(19) United States
(12) Patent Application Publication
(10) Pub. No.: US 2022/0110146 A1
(43) Pub. Date: Apr. 7, 2022

(54) DYNAMIC FULL DUPLEX COMMUNICATION

(71) Applicant: QUALCOMM Incorporated, San Diego, CA (US)

(72) Inventors: Huilin Xu, Temecula, CA (US); Muhammad Sayed Khairy Abdelghaffar, San Jose, CA (US); Wanshi Chen, San Diego, CA (US); Ahmed Attia Abotabl, San Diego, CA (US); Hwan Joon Kwon, San Diego, CA (US); Yuchul Kim, San Diego, CA (US); Abdelrahman Mohamed Mohamed Ahmed Ibrahim, San Diego, CA (US); Renqiu Wang, San Diego, CA (US); Hung Dinh Ly, San Diego, CA (US)

(21) Appl. No.: 17/407,592

(22) Filed: Aug. 20, 2021

Related U.S. Application Data
(60) Provisional application No. 63/088,660, filed on Oct. 7, 2020.

(51) Int. Cl. H04W 72/12; H04L 5/14; H04L 1/00

(52) U.S. Cl. CPC H04W 72/1289; H04L 1/0025; H04L 1/0004; H04L 5/14

(57) ABSTRACT

Methods, systems, and devices for wireless communications are described. A user equipment (UE) may receive, from a base station, a downlink control information (DCI) message scheduling a first message and including an indication that the first message is scheduled for full-duplex operation with a second message. The indication may be a DCI field configured for indicating full-duplexing, or the DCI field may be an existing DCI field configured to also indicate full-duplexing. The UE may identify a set of parameters associated with the full-duplex operation of the first message based on receiving the DCI message that includes the indication, and the UE may communicate the first message using the set of parameters associated with the full-duplex operation and based on the indication included in the DCI message.

### CROSS REFERENCE

The present Application for Patent claims the benefit of U.S. Provisional Patent Application No. 63/088,660 by Xu et al., entitled “DYNAMIC FULL DUPLEX COMMUNICATION,” filed Oct. 7, 2020, assigned to the assignee hereof, and expressly incorporated by reference herein.

### FIELD OF TECHNOLOGY

The following relates to wireless communications, including dynamic full-duplex communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may schedule a UE to operate according to a full-duplex mode where a UE may transmit and receive transmissions over the same or similar resources. Techniques for scheduling fully duplexed transmissions may be useful.

### SUMMARY

The described techniques relate to improved methods, systems, devices, and apparatuses that support dynamic full-duplex communication. Generally, a base station may dynamically and reliably indicate, to a UE, whether a pending transmission is part of a full-duplex operation via downlink control information (DCI) designs described herein. For example, a UE may receive, from a base station, a DCI message scheduling a first message and including an indication that the first message is scheduled for full-duplex operation. The indication may be a DCI field (e.g., a new DCI field) configured for indicating full-duplexing, or the DCI field may be an existing DCI field (e.g., a legacy DCI field) configured to also indicate full-duplexing. The UE may identify a set of parameters associated with the full-duplex operation of the first message based on receiving the DCI message that includes the indication, and the UE may communicate the first message using the set of parameters associated with the full-duplex operation and based on the indication included in the DCI message. In some cases, the UE may communicate the first message by transmitting, to the base station, or receiving, from the base station, the first message, where the UE transmits or receives the first message based on the DCI message.

A method of wireless communications at a UE is described. The method may include receiving, from a base station, a DCI message scheduling a first message and including an indication that the first message is scheduled for full-duplex operation, identifying a set of parameters associated with the full-duplex operation of the first message based on receiving the DCI message that includes the indication, and communicating the first message using the set of parameters associated with the full-duplex operation and based on the indication included in the DCI message.

An apparatus for wireless communications at a UE is described. The apparatus may include a processor, memory coupled with the processor, and instructions stored in the memory. The instructions may be executable by the processor to cause the apparatus to receive, from a base station, a DCI message scheduling a first message and including an indication that the first message is scheduled for full-duplex operation, identify a set of parameters associated with the full-duplex operation of the first message based on receiving the DCI message that includes the indication, and communicate the first message using the set of parameters associated with the full-duplex operation and based on the indication included in the DCI message.

Another apparatus for wireless communications at a UE is described. The apparatus may include means for receiving, from a base station, a DCI message scheduling a first message and including an indication that the first message is scheduled for full-duplex operation, identifying a set of parameters associated with the full-duplex operation of the first message based on receiving the DCI message that includes the indication, and communicating the first message using the set of parameters associated with the full-duplex operation and based on the indication included in the DCI message.

A non-transitory computer-readable medium storing code for wireless communications at a UE is described. The code may include instructions executable by a processor to receive, from a base station, a DCI message scheduling a first message and including an indication that the first message is scheduled for full-duplex operation, identify a set of parameters associated with the full-duplex operation of the first message based on receiving the DCI message that includes the indication, and communicate the first message using the set of parameters associated with the full-duplex operation and based on the indication included in the DCI message.

Some examples of the method, apparatuses, and non-transitory computer-readable medium described herein may further include operations, features, means, or instructions for receiving, from the base station, a second DCI message scheduling a second message and including a second indication that the second message may be scheduled for the full-duplex operation with the first message.

Some examples of the method, apparatuses, and non-transitory computer-readable medium described herein may further include operations, features, means, or instructions for communicating the second message based on the indication included in the second DCI message.

In some examples of the method, apparatuses, and non-transitory computer-readable medium described herein, communicating the first message and communicating the second message further may include operations, features, means, or instructions for transmitting, to the base station, the first message during a time interval based on the DCI message, and receiving, from the base station, the second message during the time interval based on the second DCI message.

Some examples of the method, apparatuses, and non-transitory computer-readable medium described herein may further include operations, features, means, or instructions for determining a failure by the UE to receive a second DCI message scheduling a second message for the full-duplex operation with the first message, and communicating the first message using the set of parameters and based on the indication included in the DCI message.

In some examples of the method, apparatuses, and non-transitory computer-readable medium described herein, the indication includes one bit of a field in the DCI message, the one bit indicating whether the first message scheduled by the DCI message may be communicated using a full-duplexing mode or a half-duplexing mode.

In some examples of the method, apparatuses, and non-transitory computer-readable medium described herein, the indication includes a set of bits of a field of the DCI message, the set of bits indicating whether the first message scheduled by the DCI message may be communicated using a full-duplexing mode or a half-duplexing mode, and information related to the full-duplexing mode or the half-duplexing mode.

In some examples of the method, apparatuses, and non-transitory computer-readable medium described herein, the indication may be included in a transmission configuration indicator (TCI) state field of the DCI message or a modulation and coding scheme (MCS) field of the DCI message.

In some examples of the method, apparatuses, and non-transitory computer-readable medium described herein, the set of parameters include one or more of MCS tables, TCI states, control resource sets, power control parameters, self-interference measurements, cross-link interference (CLI) measurements, puncturing parameters, rate matching parameters, uplink timing advance (TA), a transmission power of an uplink signal, a second indication to modify the transmission power of the uplink signal, or a combination thereof.

In some examples of the method, apparatuses, and non-transitory computer-readable medium described herein, the indication includes a UE-specific indication, or the DCI message includes a UE-specific DCI message.

In some examples of the method, apparatuses, and non-transitory computer-readable medium described herein, receiving the DCI message further may include operations, features, means, or instructions for receiving the DCI message including the indication that the first message may be scheduled to be communicated in a slot that may be associated with full-duplexing.

Some examples of the method, apparatuses, and non-transitory computer-readable medium described herein may further include operations, features, means, or instructions for determining to modify a transmission power used by the UE to transmit the first message based on the indication.

In some examples of the method, apparatuses, and non-transitory computer-readable medium described herein, the UE may be configured with a scheduling offset between receiving the DCI message and communicating the first message above a threshold, the scheduling offset including a number of symbols from an end of the DCI message to a start of the first message.

In some examples of the method, apparatuses, and non-transitory computer-readable medium described herein, the UE receives the DCI message on a first carrier and the DCI message indicates scheduling the first message on a second carrier, the DCI message indicating inter-cell full-duplexing or half-duplexing.

In some examples of the method, apparatuses, and non-transitory computer-readable medium described herein, the UE receives the DCI message on a first carrier and the DCI message indicates scheduling the first message on the first carrier during a time interval and indicates scheduling a second message on a second carrier during the time interval.

In some examples of the method, apparatuses, and non-transitory computer-readable medium described herein, the first message may be an uplink transmission and the second message may be a downlink transmission, or vice versa.

In some examples of the method, apparatuses, and non-transitory computer-readable medium described herein, the UE receives the DCI message on a downlink frequency band and the DCI message indicates scheduling the first message on the first downlink frequency band during a time interval and indicates scheduling a second message on an uplink frequency band during the time interval, or vice versa.

Some examples of the method, apparatuses, and non-transitory computer-readable medium described herein may further include operations, features, means, or instructions for selecting a communication beam for communicating the first message based on the indication included in the DCI message, where communicating the first message may be based on selecting the communication beam.

A method of wireless communications at a base station is described. The method may include determining to schedule a first message for full-duplex operation with a second message, transmitting, to a UE, a DCI message scheduling the first message and including an indication that the first message is scheduled for the full-duplex operation based on the determination, and communicating the first message using a set of parameters associated with the full-duplex operation based on the indication included in the DCI message.

An apparatus for wireless communications at a base station is described. The apparatus may include a processor, memory coupled with the processor, and instructions stored in the memory. The instructions may be executable by the processor to cause the apparatus to determine to schedule a first message for full-duplex operation with a second message, transmit, to a UE, a DCI message scheduling the first message and including an indication that the first message is scheduled for the full-duplex operation based on the determination, and communicate the first message using a set of parameters associated with the full-duplex operation based on the indication included in the DCI message.

Another apparatus for wireless communications at a base station is described. The apparatus may include means for determining to schedule a first message for full-duplex operation with a second message, transmitting, to a UE, a DCI message scheduling the first message and including an indication that the first message is scheduled for the full-duplex operation based on the determination, and communicating the first message using a set of parameters associated with the full-duplex operation based on the indication included in the DCI message.

A non-transitory computer-readable medium storing code for wireless communications at a base station is described. The code may include instructions executable by a processor to determine to schedule a first message for full-duplex operation with a second message, transmit, to a UE, a DCI message scheduling the first message and including an indication that the first message is scheduled for the full-duplex operation based on the determination, and communicate the first message using a set of parameters associated with the full-duplex operation based on the indication included in the DCI message.

Some examples of the method, apparatuses, and non-transitory computer-readable medium described herein may further include operations, features, means, or instructions for transmitting, to the UE, a second DCI message scheduling the second message and including a second indication that the second message may be scheduled for the full-duplex operation with the first message.

Some examples of the method, apparatuses, and non-transitory computer-readable medium described herein may further include operations, features, means, or instructions for communicating the second message based on the indication included in the second DCI message.

In some examples of the method, apparatuses, and non-transitory computer-readable medium described herein, communicating the first message and communicating the second message further may include operations, features, means, or instructions for receiving, from the UE, the first message during a time interval based on the DCI message, and transmitting, to the UE, the second message during the time interval based on the second DCI message.

In some examples of the method, apparatuses, and non-transitory computer-readable medium described herein, the indication includes one bit of a field in the DCI message, the one bit indicating whether the first message scheduled by the DCI message may be communicated using a full-duplexing mode or a half-duplexing mode.

In some examples of the method, apparatuses, and non-transitory computer-readable medium described herein, the indication includes a set of bits of a field of the DCI message, the set of bits indicating whether the first message scheduled by the DCI message may be communicated using a full-duplexing mode or a half-duplexing mode, and information related to the full-duplexing mode or the half-duplexing mode.

In some examples of the method, apparatuses, and non-transitory computer-readable medium described herein, the indication may be included in a TCI state field of the DCI message or a MCS field of the DCI message.

In some examples of the method, apparatuses, and non-transitory computer-readable medium described herein, the set of parameters include one or more of MCS tables, TCI states, control resource sets, power control parameters, self-interference measurements, CLI measurements, puncturing parameters, rate matching parameters, uplink TA, a transmission power of an uplink signal, a second indication to modify the transmission power of the uplink signal, or a combination thereof.

In some examples of the method, apparatuses, and non-transitory computer-readable medium described herein, the indication includes a UE-specific indication, or the DCI message includes a UE-specific DCI message.

In some examples of the method, apparatuses, and non-transitory computer-readable medium described herein, transmitting the DCI message further may include operations, features, means, or instructions for transmitting the DCI message including the indication that the first message may be scheduled to be communicated in a slot that may be associated with full-duplexing.

Some examples of the method, apparatuses, and non-transitory computer-readable medium described herein may further include operations, features, means, or instructions for determining to include, in the indication, instructions for the UE to modify a transmission power used by the UE to transmit the first message.

In some examples of the method, apparatuses, and non-transitory computer-readable medium described herein, the base station may be configured with a scheduling offset between transmitting the DCI message and communicating the first message above a threshold, the scheduling offset including a number of symbols from an end of the DCI message to a start of the first message.

In some examples of the method, apparatuses, and non-transitory computer-readable medium described herein, the base station transmits the DCI message on a first carrier and the DCI message indicates scheduling the first message on a second carrier, the DCI message indicating inter-cell full-duplexing or half-duplexing.

In some examples of the method, apparatuses, and non-transitory computer-readable medium described herein, the base station transmits the DCI message on a first carrier and the DCI message indicates scheduling the first message on the first carrier during a time interval and indicates scheduling a second message on a second carrier during the time interval.

In some examples of the method, apparatuses, and non-transitory computer-readable medium described herein, the first message may be an uplink transmission and the second message may be a downlink transmission, or vice versa.

In some examples of the method, apparatuses, and non-transitory computer-readable medium described herein, the base station transmits the DCI message on a downlink frequency band and the DCI message indicates scheduling the first message on the first downlink frequency band during a time interval and indicates scheduling a second message on an uplink frequency band during the time interval, or vice versa.

### BRIEF DESCRIPTION OF THE DRAWINGS

FIG. 1 illustrates an example of a wireless communications system that supports dynamic full-duplex communication in accordance with aspects of the present disclosure.

FIG. 2 illustrates an example of a wireless communications system that supports dynamic full-duplex communication in accordance with aspects of the present disclosure.

FIG. 3 illustrates examples of DCI configurations that support dynamic full-duplex communication in accordance with aspects of the present disclosure.

FIG. 4 illustrates an example of a timeline that supports dynamic full-duplex communication in accordance with aspects of the present disclosure.

FIGS. 5A through 5C illustrate examples of timelines that support dynamic full-duplex communication in accordance with aspects of the present disclosure.

FIG. 6 illustrates an example of a process flow that supports dynamic full-duplex communication in accordance with aspects of the present disclosure.

FIGS. 7 and 8 show diagrams of devices that support dynamic full-duplex communication in accordance with aspects of the present disclosure.

FIG. 9 shows a diagram of a communications manager that supports dynamic full-duplex communication in accordance with aspects of the present disclosure.

FIG. 10 shows a diagram of a system including a device that supports dynamic full-duplex communication in accordance with aspects of the present disclosure.

FIGS. 11 and 12 show diagrams of devices that support dynamic full-duplex communication in accordance with aspects of the present disclosure.

FIG. 13 shows a diagram of a communications manager that supports dynamic full-duplex communication in accordance with aspects of the present disclosure.

FIG. 14 shows a diagram of a system including a device that supports dynamic full-duplex communication in accordance with aspects of the present disclosure.

FIGS. 15 through 18 show flowcharts illustrating methods that support dynamic full-duplex communication in accordance with aspects of the present disclosure.

### DETAILED DESCRIPTION

Some wireless communications systems may support full-duplex operations (e.g., in which a UE is capable of simultaneously transmitting and receiving). A base station may schedule full-duplex operations (e.g., uplink and downlink transmissions that overlap in time, frequency, or both) using DCI messages. For instance, the base station may transmit a first DCI (e.g., a legacy DCI) scheduling an uplink transmission, and may transmit a second DCI (e.g., a legacy DCI) scheduling a downlink transmission that overlaps in time with the uplink transmission. To perform the full-duplex operation, the UE may identify that the transmissions at least partially overlap and adjust one or more parameters to process the overlapping uplink and downlink transmissions. Such parameters may include MCS tables, TCI states, beam configurations or assumptions, power control parameters, system information (SI) and CLI measurement, puncturing or rate matching around demodulation reference signals (DMRS), uplink TA values, or the like. Different parameters may be used for half-duplex operations than the parameters used for full-duplex operations. Thus, if a UE fails to receive or decode one of the two DCIs, then the UE may fail to receive or transmit the transmission associated with the failed DCI, and may also communicate (e.g., transmit or receive) the other transmission using the wrong parameters. For instance, the UE may falsely assume that the UE can rely on uplink/downlink beam correspondence, and may select the wrong beams for an uplink or downlink transmission. This may result in failed transmissions or retransmissions, increased system congestion, increased system latency, and decreased user experience.

A base station may dynamically and reliably indicate whether pending transmissions are part of a full-duplex operation via DCI designs described herein. For example, a UE may receive, from a base station, a DCI message scheduling a first message and including an indication that the first message is scheduled for full-duplex operation. The indication may be a DCI field (e.g., a new DCI field) configured for indicating full-duplexing, or the DCI field may be an existing DCI field (e.g., legacy DCI field) configured to also indicate full-duplexing. The UE may identify a set of parameters associated with the full-duplex operation of the first message based on receiving the DCI message that includes the indication, and the UE may communicate the first message using the set of parameters associated with the full-duplex operation and based on the indication included in the DCI message. In some cases, the UE may communicate the first message by transmitting, to the base station, or receiving, from the base station, the first message, where the UE transmits or receives the first message based on the DCI message. In such cases, the UE may communicate the first message using the appropriate set of parameters (e.g., parameters associated with full-duplex operations) even if the UE does not receive a second DCI message that schedules a second message that is associated with the full-duplex operation.

Particular aspects of the subject matter described herein may be implemented to realize one or more advantages. The described techniques may support improvements in system efficiency such that a UE is more likely to successfully decode DCI and accurately identify whether a full-duplex operation or a half-duplex operation is scheduled. Such improvements in determining an operation type may allow the UE to more accurately select transmission or reception parameters, resulting in increased likelihood of successful transmissions, decreased retransmissions and failed transmissions, improved system efficiency, decreased system latency, and improved user experience.

Aspects of the disclosure are initially described in the context of wireless communications systems. Aspects are then described with reference to DCI configurations, timelines, and a process flow. Aspects of the disclosure are further illustrated by and described with reference to apparatus diagrams, system diagrams, and flowcharts that relate to dynamic full-duplex communication.

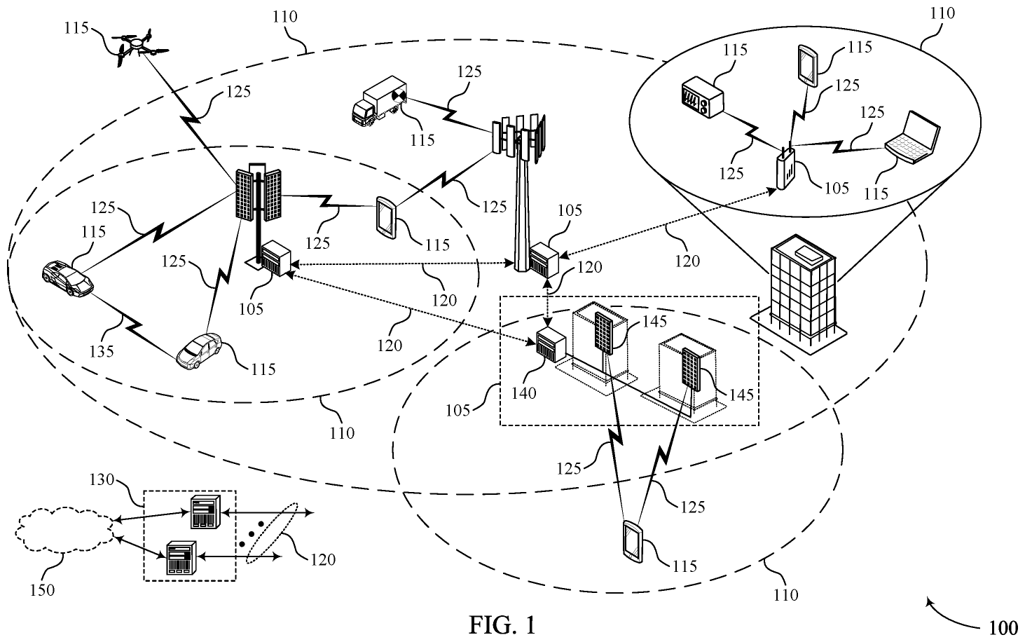

FIG. 1 illustrates an example of a wireless communications system 100 that supports dynamic full-duplex communication in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may dynamically and reliably indicate that pending transmissions are part of a full-duplex operation via DCI designs described herein. For example, a UE 115 may receive, from a base station 105, a DCI message scheduling a first message and including an indication that the first message is scheduled for full-duplex operation. The indication may be a DCI field (e.g., a new DCI field) configured for indicating full-duplexing, or the DCI field may be an existing DCI field (e.g., legacy DCI field) configured to also indicate full-duplexing. The UE 115 may identify a set of parameters associated with the full-duplex operation of the first message based on receiving the DCI message that includes the indication, and the UE 115 may communicate the first message using the set of parameters associated with the full-duplex operation and based on the indication included in the DCI message. In some cases, the UE 115 may communicate the first message by transmitting, to the base station 105, or receiving, from the base station 105, the first message, where the UE 115 transmits or receives the first message based on the DCI message. In such a case, the UE 115 may communicate the first message using the appropriate set of parameters (e.g., parameters associated with full-duplex operations) even if the UE 115 does not receive a second DCI message scheduling a second message that is associated with the full-duplex operation.

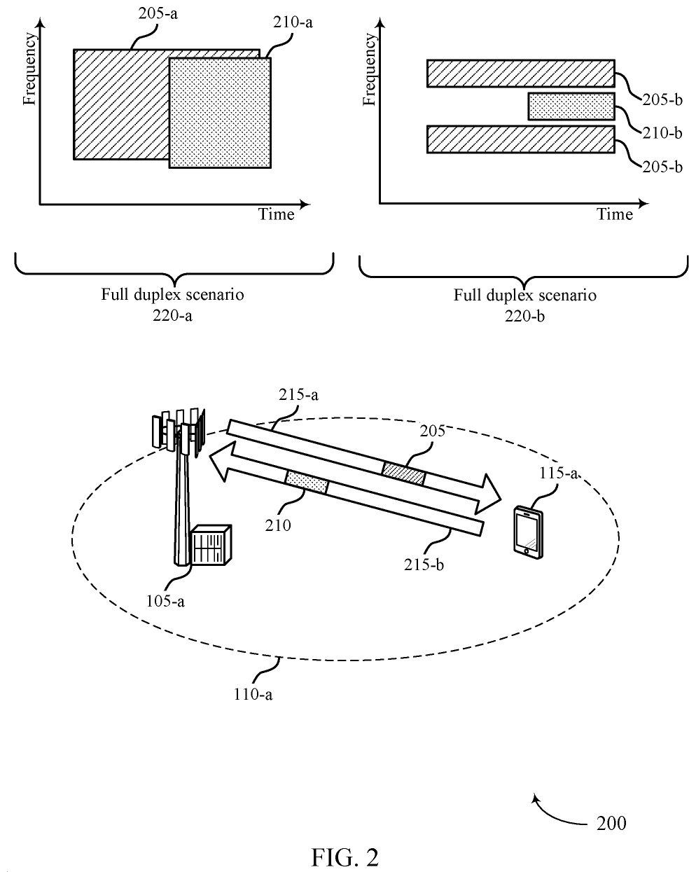

FIG. 2 illustrates an example of a wireless communications system 200 that supports dynamic full-duplex communication in accordance with aspects of the present disclosure. Wireless communications system 200 may include base station 105-a and UE 115-a, which may be examples of a base station 105 and a UE 115 as described with reference to FIG. 1. Base station 105-a may serve a geographic coverage area 110-a. In some cases, wireless communications system 200 may support a full-duplex scenario.

In some cases, such as in wireless communications system 200, UE 115-a may communicate with base station 105-a via communication links 215. For example, base station 105-b may transmit one or more DCI messages and/or one or more scheduled downlink transmissions (e.g., physical downlink shared channel (PDSCH) 205) to UE 115-a via communication link 215-a. UE 115-a may transmit one or more scheduled uplink transmissions (e.g., physical uplink shared channel (PUSCH) 210) to base station 105-b via communication link 215-b. The one or more uplink transmissions and downlink transmissions may be scheduled according to a duplexing mode, such as a full-duplexing mode or a half-duplexing mode. For example, a UE 115 may support full-duplex operations.

In a full-duplex operation, a UE 115 (e.g., UE 115-a) may simultaneously receive downlink transmissions and perform uplink transmissions during one or more communication resources (e.g., time intervals such as symbols and/or frequency bands or subbands) that support full-duplex transmissions. Full-duplex operation may be based on receiving DCI that triggers uplink transmissions and downlink transmissions.

In some examples, UE 115-a may support full band full-duplex operations, as illustrated with reference to full-duplex scenario 220-a. Base station 105-a may schedule, via a DCI message including a downlink grant, downlink data transmissions on PDSCH 205-a. PDSCH 205-a may span some or all of a frequency band (e.g., a continuous frequency band). In some examples, base station 105-a may also schedule, via a second DCI message including an uplink grant, uplink data transmissions on PUSCH 210-a. In some examples, PUSCH 210-a may span some or all of the frequency band, such that PDSCH 205-a and PUSCH 210-a share at least a portion the same frequency band. Thus, for at least some time interval (e.g., symbol periods), PUSCH 210-a and PDSCH 205-a may overlap in time and frequency.

In some examples, UE 115-a may support subband full-duplex operations, as illustrated with reference to full-duplex scenario 220-b. Base station 105-a may schedule, via one or more DCI messages including one or more downlink grants, a first portion of PDSCH 205-b on a first subband and a second portion of PDSCH 205-b on a second subband, where the first and second portion of the PDSCH 205-b are a part of the same PDSCH 205-b. Additionally, base station 105-a may schedule, via another DCI message including an uplink grant, a PUSCH 210-b on a third subband. Thus, PUSCH 210-b may overlap in time for a duration of time (e.g., a number of symbol periods, number of milliseconds, number of slots) with PDSCH 205-b.

In conventional communications systems, a UE 115 may determine that a transmission is scheduled as a full-duplexed transmission based on receiving a first DCI that schedules a downlink transmission and a second DCI that schedules an uplink transmission in overlapping resources with the uplink transmission. For example, base station 105-a may transmit a first DCI scheduling a PDSCH 205 and a second DCI scheduling a PUSCH 210 that at least partially overlaps in time with the PDSCH 205. If UE 115-a receives and successfully decodes both the first DCI and the second DCI, then UE 115-a may prepare to perform a full-duplex operation based on an overlapping portion of PDSCH 205 and PUSCH 210. However, if UE 115 receives just one of the DCIs (e.g., the first DCI or the second DCI), then UE 115-a may erroneously determine that a half-duplex operation is scheduled (either a transmission on the PUSCH 210 or a reception on the PDSCH 205, but not both at the same time). UE 115-a may communicate with base station 105 using different parameters for a half-duplex operation than UE 115-a uses for a full-duplex operation. Such parameters may include MCS tables, TCI states, power control parameters, system information measurements, CLI measurements, puncturing or rate matching around DMRSs, uplink TA values, beam indices or beam correspondence values, or the like. Thus, if UE 115-a receives a single DCI and fails to decode the other DCI, then UE 115-a may assume UE 115-a is configured to perform a half-duplex operation. The UE 115-a may prepare to perform an uplink transmission on the PUSCH 210, or prepare to receive a downlink transmission on the PDSCH 205 using the half-duplex parameters (instead of the full-duplex parameters). In such cases, UE 115 may fail to decode the scheduled downlink transmission or base station 105 may fail to receive the scheduled uplink transmissions based on the UE 115 using the wrong parameters.

For example, in a half-duplex operation, UE 115-a may determine that uplink/downlink beam correspondence exists and may select transmit beams or receive beams accordingly. However, in a full-duplex operation, UE 115-a may not determine that uplink/downlink beam correspondence exists because a transmission of the full-duplex operation received by a UE 115 or a base station 105 may capture a reflection (e.g., a strong or significant reflection) from the corresponding transmission of the full-duplex operation transmitted by the UE 115 or base station 105. Base station 105-a may determine a receive beam or transmit beam to use according to whether UE 115-a is configured for full-duplex operation or half-duplex operation. However, if UE 115-a misses (e.g., fails to decode) either the first DCI or the second DCI, then UE 115-a may determine that uplink/downlink beam correspondence exists and may select a beam based on this determination, while base station 105-a may determine that UE 115-a cannot rely on uplink/downlink beam correspondence in a full-duplex mode and may select a beam based on that determination. Based on the mismatch of determinations, UE 115-a and base station 105-a may select mismatched beams and may fail to receive uplink or downlink communications. Thus, if scheduling DCIs for overlapping downlink and uplink transmissions are missed, or are not easily decodable, then transmissions may fail, latency may increase, and user experience may suffer.

In some examples, as described herein, base station 105 may dynamically schedule full-duplex operations using DCIs that indicate the full-duplex operations. For instance, base station 105 may schedule overlapping uplink and downlink transmissions (e.g., PDSCH 205 and PUSCH 210) using a duplexing flag included in each scheduling DCI. For example, base station 105-a may configure a first DCI message that schedules a first transmission, such as PDSCH 205, and includes an indication of whether the first transmission being scheduled by the first DCI message is scheduled according to a full-duplex operation. Base station 105-a may also configure a second DCI message that schedules a second transmission, such as PUSCH 210, and includes an indication of whether the second transmission being scheduled by the second DCI is scheduled according to a full-duplex operation. For example, base station 105-a may schedule the PDSCH 205 and PUSCH 210 such that the two transmissions have a full-duplexing relationship (e.g., full band or subband duplexing relationship). Base station 105-a may configure the first DCI to include the indication that the first transmission is scheduled according to a full-duplex operation and may configure the second DCI to include the indication that the second transmission is scheduled according to a full-duplex operation. As such, if UE 115-a fails to decode the first DCI or the second DCI, then the UE will still perform the transmission based on the received DCI with the appropriate, full-duplexing parameters.

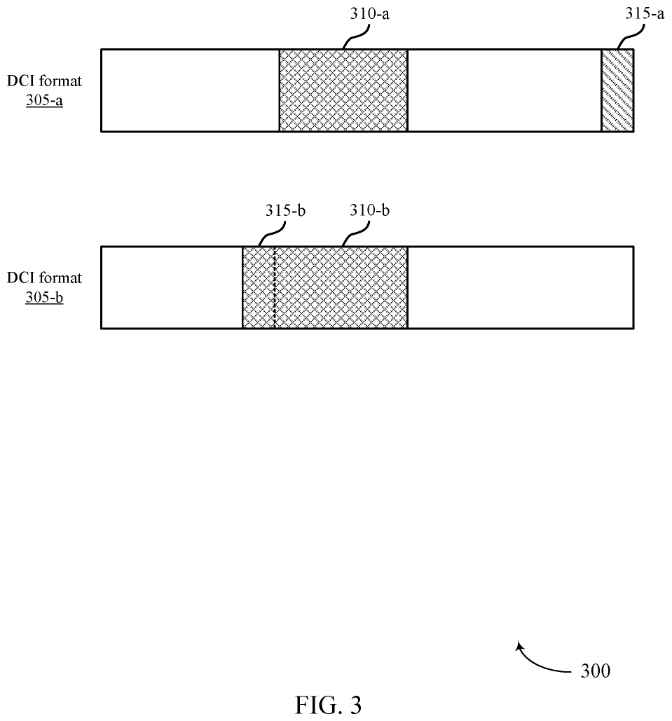

FIG. 3 illustrates an example of DCI configurations 300 that support dynamic full-duplex communication in accordance with aspects of the present disclosure. The DCI configurations 300 may be implemented and used by a UE and a base station of a wireless communications system, as described with reference to FIGS. 1 and 2. For example, a base station may configure a DCI message according to a DCI configuration and transmit the DCI message to be received and decoded by a UE, where the base station may configure the DCI message based on a full-duplexing operation. The base station may serve a geographic coverage area.

A base station may configure and transmit a DCI message to a UE to indicate a scheduled transmission. The scheduled transmission may be scheduled according to a full-duplex operation or a half-duplex operation. In some cases, the base station may configure the DCI to include an indication of whether the message being scheduled by the DCI is scheduled according to a full-duplex operation or a half-duplex operation.

In some implementations, the base station may configure the DCI message based on DCI format 305-a, where the duplexing indication is included in the DCI message as a duplexing field 315-a (e.g., a new DCI field). For example, DCI format 305-a may include a number of DCI fields, such as field 310-a, where field 310-a may be a legacy DCI field, such as a TCI state field, or MCS field. The duplexing indication may be included in field 315-a that may be a duplexing-specific field (e.g., a field dedicated to indicating a duplexing mode associated with the DCI). The field 315-a may include one bit (or any number of bits) that may be used by a base station to indicate whether the transmission being scheduled by the DCI is a full-duplex transmission. The location of the duplexing field 315-a within the DCI format 305 may be preconfigured or signaled (e.g., dynamically, semi-statically, or aperiodically) to the base station and/or the UE.

In some implementations, the base station may configure the DCI message based on DCI format 305-b, where the duplexing indication is included in the DCI message as a duplexing field 315-b. Duplexing field 315-b may be included in a legacy DCI field 310-b, such as a TCI state field, or MCS field. The field 315-b may include one bit (or any number of bits) that may be used by a base station to indicate whether the transmission being scheduled by the DCI is a full-duplex transmission. As such, the one bit (or the any quantity of bits) may be added to the legacy DCI field 310-b that the duplexing indication (e.g., duplexing field 315-b) is being added to. In some cases, the one or more bits of the duplexing field 315-b may be added to the start or the end of the legacy DCI field 310-b. The base station may determine two sets of candidate values of the field separately for full-duplexing and half-duplexing, where the bit number of the legacy DCI field 310-b may be increased to differentiate full-duplex and half-duplex transmissions.

In some examples, the legacy DCI field 310-b may be configured with 3 bits, and to include the duplexing indication (e.g., duplexing field 315-b), the base station may determine to include four (4) bits in the legacy DCI field 310-b, where the one (1) additional bit is a part of the duplexing field 315-b and used to indicate the duplexing mode. Based on the value of the duplexing bit, the base station and the UE may interpret the rest of the bits of the legacy DCI field 310-b differently. In such an example, values 0 through 7 that may be indicated by the four (4) bits may be associated with half-duplex scheduling, and values 8 through 15 that may be indicated by the four (4) bits may be associated with full-duplex scheduling, where the duplexing bit may indicate which set to use. For example, a 1-bit may be associated with full-duplexing and a 0-bit may be associated with half-duplexing, or vice versa. If the legacy field 315-b (e.g., a TCI field) including the duplexing indication includes four (4) bits, and the bit associated with duplexing is 1, the rest of the bits (e.g., the other three (3) bits), of the legacy field may be associated with full-duplexing such that the remaining bits may activate 1 of 8 TCI states associated with the full-duplexing mode. Alternatively, if the legacy field 315-b (e.g., a TCI field) includes 4 bits, and the bit associated with duplexing is 0, the rest of the bits (e.g., the other 3 bits) of the legacy field may be associated with half-duplexing such that the remaining bits may activate 1 of 8 TCI states associated with the half-duplexing mode. The 8 TCI states associated with the full-duplexing mode and the 8 TCI states associated with the half-duplexing mode may be different, or partially different.

In some cases, the base station may configure the DCI message to include the duplexing indication if the transmission being scheduled is scheduled as a full-duplex transmission. For example, if a base station is configuring a transmission according to full-duplex operation, then the base station may configure the DCI message to include an indication that the transmission being scheduled by the DCI is scheduled based on a full-duplex operation. Alternatively, if the base station is scheduling a transmission according to a half-duplex operation, the base station may not configure the DCI message with a duplexing indication. The UE may receive the DCI and identify, based on a lack of a duplexing indication, that the scheduled transmission is a half-duplex transmission.

In the case that the UE receives a DCI message according to DCI format 305-a or according to DCI format 305-b, the UE may perform an action based on the duplexing indication. For example, if the UE receives a DCI message including the duplexing field 315 that schedules a downlink transmission, the UE may be configured to use a certain MCS table, a set of TCI states, control resources sets, etc. based on the duplexing mode indicated by the duplexing field 315. If the UE receives a DCI message including the duplexing field 315 that schedules an uplink transmission, the UE may be configured to use a certain TA, uplink power control loop, etc. based on the duplexing mode indicated by the duplexing field 315. The UE may be preconfigured, or receive signaling (e.g., dynamically, periodically, semi-statically) indicating which parameters to use for which duplexing mode.

In some cases, the duplexing field 315 (e.g., duplexing flag) may be UE-specific, or the DCI message including the duplexing field 315 may be UE-specific. For example, the base station may configure the DCI message as a UE-specific DCI message if the base station is configuring the DCI message to include the duplexing field 315 that indicates the DCI message is scheduling a full-duplex or half-duplexing transmission. A group-common DCI may be used for the indication of slots formats (e.g., half-duplex, full-duplex).

In some implementations, slots (or some other time interval) may be assigned as full-duplexing slots, such that a slot that is assigned as a full-duplexing slot may be a potential full-duplex uplink and downlink transmission opportunity. The full-duplex (e.g., dynamic full-duplex) enabling DCI message as described herein may be applied to specific slots that are assigned as full-duplex slots. For example, slots may be defined as full-duplex slots or half-duplex slots. The base station may schedule full-duplexing communications and/or transmit DCI messages scheduling full-duplexing communications within the slots defined as full-duplex slots. In some cases, the base station may not schedule and/or transmit DCI scheduling full-duplexing communications in half-duplex configured slots. However, the base station may not be required to use the full-duplex slots for full-duplexing related communications. In some cases, the base station may leave the full-duplex configured slots empty, or, in some cases, use the full-duplex configured slots for a non-full-duplex related communication. The UE may determine that the communications scheduled by the DCI received within a full-duplex slot are scheduled according to a full-duplexing mode based at the slot in which the DCI received, or based on the duplexing field 315 received within the DCI message, or both. In some cases, the UE may receive a DCI message that includes an indication of the duplexing mode (e.g., the duplexing field 315) in a full-duplex slot. For example, a UE may not expect to receive a DCI message including an indication of duplexing mode in a half-duplexing configured slot. Additionally or alternatively, the duplexing indication may be included in any DCI message, despite the configuration of the slot in which the DCI message was received.

In some implementations, the base station may configure the duplexing field 315 (e.g., a standalone duplexing field, or a duplexing field included in a legacy field) with more than one bit. The base station may include the additional bits to indicate additional information associated with the full-duplex or half-duplex communication or the UE procedure associated with the transmission scheduled by the DCI message. For example, a single bit may indicate whether the transmission being scheduled is a half-duplex or full-duplex transmission and the additional bits included in the duplexing field 315 may indicate the type of full-duplex (e.g., full band, subband), indicate whether the transmission is fully overlapped (e.g., in time and/or frequency), indicate whether the transmission partially overlaps (e.g., in time and/or frequency), etc.

In some cases, the duplexing field 315 may implicitly or explicitly indicate the uplink transmission power of the UE such as if the duplexing field 315 is included in a DCI that schedules an uplink transmission or where the duplexing field 315 indicates a full-duplex operation where one of the two transmissions associated with the full operation is an uplink transmission. In the case of an explicit indication, the duplexing field 315 may include a number of bits to indicate that the UE should increase or decrease the transmission power of the UE based on the duplexing mode, or the duplexing field 315 may include a number of bits to indicate the transmission power the UE should operate at, or both. In the case of an implicit indication, the UE may be configured to increase or decrease the transmission power of the UE based on the duplexing mode indicated in the duplexing field. For example, the UE may receive the DCI message, identify the duplexing mode indicated in the DCI message, and adjust the transmission power of the UE accordingly. In the case of full-duplexing, the UE may be configured to reduce uplink transmission power of the UE, such as to reduce self-interference that may result from the transmission and reception of the full-duplex operation.

In some cases, the duplexing mode may apply to a single UE, such that the base station transmitting the transmission of the full-duplex operation may not be scheduled to receive the transmission of the same full-duplex operation. As such, the base station may not operate using full-duplexing parameters. However, in the case that the base station is configured as full-duplex, the UE may be configured to increase the uplink transmission power of the UE to mitigate the self-interference effect from the downlink transmission transmitted by the base station to the uplink transmission received by the base station.

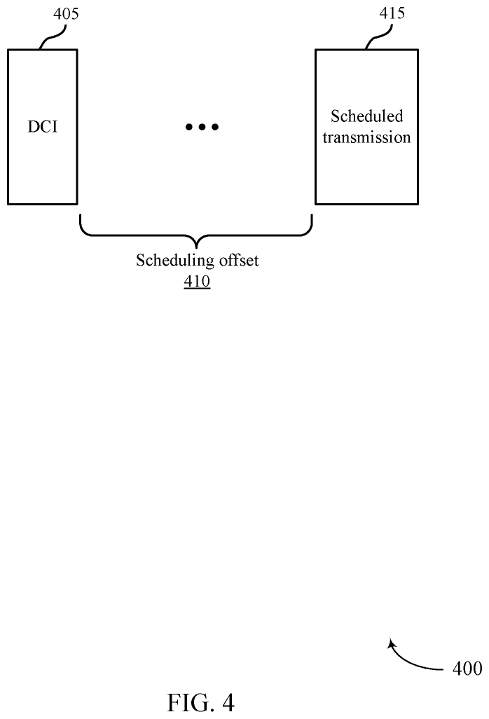

FIG. 4 illustrates an example of a timeline 400 that supports dynamic full-duplex communication in accordance with aspects of the present disclosure. The timeline 400 may be implemented and used by a UE and a base station of a wireless communications system, as described with reference to FIGS. 1 through 3. For example, a base station may configure a DCI message and transmit the DCI message to be received and decoded by a UE according to timeline 400, where the base station may configure the DCI message based on a full-duplexing operation. The base station may serve a geographic coverage area.

As described herein, a base station may transmit, to a UE, a DCI message 405 that indicates a scheduled transmission 415, where the scheduled transmission 415 may be associated with a full-duplex or half-duplex operation. In some implementations, a scheduling offset 410, such as a scheduling offset (e.g., a minimum scheduling offset), may be defined to provide the UE with enough time to switch between full-duplex operation and half-duplex operation, or vice versa. For example, a scheduling offset 410 may be defined as a time interval between the end of the DCI message 405 (e.g., from the end of the last symbol of the DCI message 405) and the start of the scheduled transmission 415 (e.g., the start of the first symbol of the scheduled transmission 415) being scheduled by the DCI message 405. The time interval of the scheduling offset 410 may be defined as an amount of time (e.g., a number of milliseconds, seconds), or as a number of slots, symbols, TTIs, etc. between the end of the scheduling message (e.g., DCI message 405) and the earliest time that the scheduled communication (e.g., scheduled transmission 415) can occur. In some cases, the base station may not schedule the transmission 415 prior to, or during the scheduling offset 410, such that the earliest the base station may schedule the transmission 415 is at the end of the scheduling offset 410. As such, the base station may determine a location to transmit the DCI message 405, determine the scheduling offset 410, and determine the location of the scheduled transmission 415 based on the location of the DCI message 405 and the scheduling offset 410.

The scheduling offset 410 may be used in any DCI message 405 that schedules a full-duplex operation, or half-duplex operation, or both. In some cases, the scheduling offset 410 may be used in any DCI that schedules a duplexing operation that is different than the previous duplexing operation performed by the UE.

The duration of the scheduling offset 410 may be preconfigured, where the base station, or the UE, or both may be preconfigured with the duration of the scheduling offset 410. In some cases, the base station may determine the duration of the scheduling offset 410 and signal the determined duration to the UE via an RRC, MAC-CE, or DCI message 405 (e.g., dynamically, semi-persistently, aperiodically).

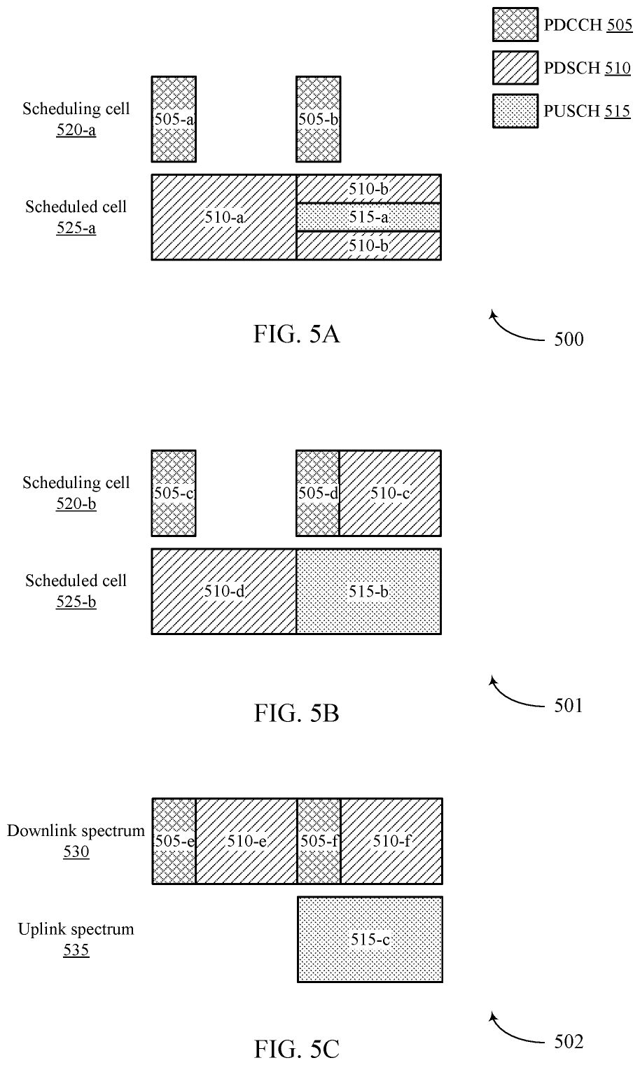

FIGS. 5A, 5B, and 5C illustrate example timelines 500, 501, and 502 that supports dynamic full-duplex communication in accordance with aspects of the present disclosure. The timelines 500, 501, and 502 may each be implemented and used by a UE and a base station of a wireless communications system, as described with reference to FIGS. 1 through 4. For example, a base station may configure a DCI message and transmit the DCI message to be received and decoded by a UE according to timelines 500, 501, and/or 502, where the base station may configure the DCI message based on a full-duplexing operation. The base station may serve a geographic coverage area.

As described herein, a base station may transmit, to a UE, a DCI message that indicates a scheduled transmission, where the scheduled transmission may be associated with a full-duplex or half-duplex operation. The DCI message may be transmitted via a physical downlink control channel (PDCCH) 505, and the scheduled transmission may be scheduled as part of a PDSCH 510, or PUSCH 515, or both. In some cases, the DCI message may schedule half-duplex or full-duplex operations across carriers (e.g., inter-carrier).

FIG. 5A illustrates an example of cross-carrier scheduling. For example, a UE may receive a DCI message in PDCCH 505-a on scheduling cell 520-a (e.g., on resource associated with the scheduling cell 520-a). The DCI message may indicate one or more scheduled transmissions (e.g., PDSCH 510, PUSCH 515), and/or indicate the duplexing mode associated with the one or more scheduled transmissions. In such cases, a UE may receive DCI messages in one cell (e.g., a scheduling cell 520-a) that schedules transmissions in another cell (e.g., scheduled cell 525-a). The UE may receive PDCCHs 505-a and 505-b in the scheduling cell 520-a that may each include a DCI message. The DCI messages received on the scheduling cell 520-a may schedule one or more of PDSCH 510-a, PDSCH 510-b, and PUSCH 515-a. For example, PDCCH 505-a may include a first DCI message that schedules the PDSCH 510-b and include a second DCI message that schedules the PUSCH 515-a. The first and second DCI messages may each include an indication of the duplexing operation associated with the transmissions being scheduled by each DCI message. For example, the first DCI message may include an indication that PDSCH 510-b is part of a full-duplexing operation and the second DCI message may include an indication the PUSCH 515-a is part of a full-duplexing operation. In some cases, the PDCCH 505 may schedule transmissions in a subsequent slot. For example, PDCCH 505-a may be in a different slot than PDSCH 510-b and PUSCH 515-a scheduled by PDCCH 505-a.

FIG. 5B illustrates an example of carrier aggregation. In some cases, FIG. 5B may illustrate an example of intra-band (e.g., intra-frequency band) carrier aggregation that includes multiple TDD cells in the same frequency band. In such a case, a DCI message received on a scheduling cell 520-b (e.g., a first TDD cell) may indicate scheduling on one or more TDD cells, such as scheduled cell 525-b. Additionally or alternatively, cell 520-b may receive a DCI message (that schedules uplink and/or downlink communications) on the same cell 520-b (e.g., self-scheduling), and/or cell 525-b may receive a DCI message (that schedules uplink and/or downlink communications) on the same cell 525-b (e.g., self-scheduling). In some wireless communications systems (e.g., 5G NR), symbols may be flexible such that symbols may be dynamically used for uplink or downlink transmissions. In the case that the intra-band carrier aggregation is used in such a wireless communications system, a DCI may be used to indicate the dynamic uplink and downlink symbols across TDD cells within the same frequency band. The DCI message may be used to indicate whether a TDD cell is scheduled with a downlink transmission and another TDD cell is scheduled with an uplink transmission in an overlapping time duration (e.g., symbols). For example, a UE may receive one or more PDCCHs 505, such as PDCCH 505-c and 505-d, on scheduling cell 520-b. The PDCCHs 505 may include one or more DCI messages that each schedule a transmission (e.g., PDSCH 510-c, PDSCH 510-d, PUSCH 515-b) on the scheduling cell 520-b or the scheduled cell 525-b. For example, one or more DCI messages in PDCCH 505-c may indicate that PDSCH 510-c is scheduled on scheduling cell 520-b and that PDSCH 510-c is a part of a full-duplex operation, and the one or more DCI messages may indicate that PUSCH 515-b is scheduled on the scheduled cell 525-b and that the PUSCH 515-b is part of a full-duplex operation. In some cases, the PDCCH 505 may schedule transmissions in a subsequent slot. For example, PDCCH 505-c may be in a different slot than PDSCH 510-c and PUSCH 515-b scheduled by PDCCH 505-c.

FIG. 5C illustrates an example of FDD operation. In some cases, the example of FIG. 5C may indicate whether an FDD cell is scheduled with simultaneous downlink and uplink transmissions in a time duration (e.g., overlapping symbol). For example, a UE may be communicating in an FDD cell that includes a downlink spectrum 530 (e.g., a downlink frequency band) and an uplink spectrum 535 (e.g., an uplink frequency band). A UE may receive one or more PDCCHs 505 (e.g., PDCCHs 505-e and 505-f) on the downlink spectrum 530, where each PDCCH 505 may include one or more DCI messages that schedule transmissions on the downlink spectrum 530 (e.g., PDSCH 510-e, PDSCH 510-f) and/or the uplink spectrum 535 (e.g., PUSCH 515-c). For example, PDCCH 505-e may include one or more DCI messages that schedule the PDSCH 510-f and indicate that PDSCH 510-f is scheduled as part of a full-duplex operation and schedule the PUSCH 515-c and indicate that PUSCH 515-c is scheduled as part of a full-duplex operation. In some cases, the PDCCH 505 may schedule transmissions in a subsequent slot. For example, PDCCH 505-e may be in a different slot than PDSCH 510-f and PUSCH 515-c scheduled by PDCCH 505-e.

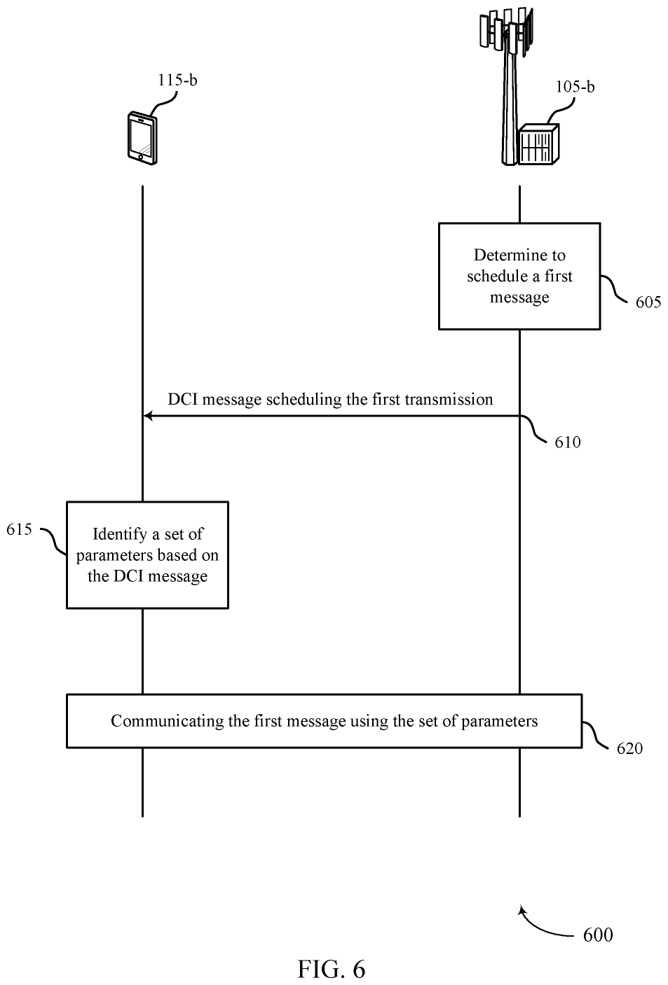

FIG. 6 illustrates an example of a process flow 600 that supports dynamic full-duplex communication in accordance with aspects of the present disclosure. The process flow 600 may illustrate an example duplexing indication procedure. For example, base station 105-b may configure and transmit one or more DCI messages to UE 115-b that indicate one or more scheduled transmissions and whether the scheduled transmissions are scheduled in a full-duplexing operation or a half-duplexing operation. Base station 105-b and UE 115-b may be examples of the corresponding wireless devices described with reference to FIGS. 1 through 5C. In some cases, instead of base station 105-b implementing the duplexing indication procedure, a different type of wireless device (e.g., a UE 115) may perform the procedure. Alternative examples of the following may be implemented, where some steps are performed in a different order than described or are not performed at all. In some cases, steps may include additional features not mentioned below, or further steps may be added.

At 605, base station 105-b may determine to schedule a first message for full-duplex operation with a second message.

At 610, base station 105-b may transmit, to UE 115-b, a DCI message scheduling a first message and including an indication that the first message is scheduled for full-duplex operation. In some cases, base station 105-b may transmit, to UE 115-b, a second DCI message scheduling a second message and including a second indication that the second message is scheduled for the full-duplex operation with the first message.

The indication may include one bit of a field in the DCI message, the one bit indicating whether the first message scheduled by the DCI message is communicated using a full-duplexing mode or a half-duplexing mode. Additionally or alternatively, the indication may include a plurality of bits of a field of the DCI message, the plurality of bits indicating whether the first message scheduled by the DCI message is communicated using a full-duplexing mode or a half-duplexing mode, and information related to the full-duplexing mode or the half-duplexing mode.

In some cases, the indication may be included in a TCI state field of the DCI message or an MCS field of the DCI message. Additionally or alternatively, the indication may be included in a separate DCI field (e.g., a new DCI field). The indication may be a UE-specific indication or a group-common indication. The DCI message may be a UE-specific DCI message, or the DCI message may be a group-common DCI message.

In some cases, base station 105-b may transmit the DCI message including the indication that the first message is scheduled to be communicated in a slot that is associated with full-duplexing. UE 115-b and/or base station 105-b may be configured with a scheduling offset between receiving/transmitting the DCI message and communicating the first message. The scheduling offset may include a number of symbols from an end of the DCI message to a start of the first message, or the second message.

UE 115-b may receive the DCI message on a first carrier and the DCI message may indicate scheduling the first message on a second carrier. The DCI message may indicate inter-cell full-duplexing or half-duplexing as described with reference to FIG. 5A. In some implementations, UE 115-b may receive the DCI message on a first carrier and the DCI message may indicate scheduling the first message on the first carrier during a time interval and may indicate scheduling a second message on a second carrier during the time interval (e.g., the first and second message may overlap in a time interval, such as a number of symbols). In such a case, the DCI may indicate intra-band carrier aggregation scheduling as described with reference to FIG. 5B. The first message is an uplink transmission and the second message is a downlink transmission, or vice versa. In some implementations, UE 115-b may receive the DCI message on a downlink frequency band (e.g., downlink spectrum) and the DCI message may indicate scheduling the first message on the first downlink frequency band during a time interval and may indicate scheduling a second message on an uplink frequency band (e.g., uplink spectrum) during the time interval, or vice versa (e.g., the first and second message may overlap in a time interval, such as a number of symbols). In such a case, the DCI may indicate scheduling within an FDD operation as described with reference to FIG. 5C.

At 615, UE 115-b may identify a set of parameters associated with the full-duplex operation of the first message based on receiving the DCI message that includes the indication. The set of parameters may include one or more of MCS tables, TCI states, control resource sets, power control parameters, self-interference measurements, CLI measurements, puncturing parameters, rate matching parameters, uplink TA, a transmission power of an uplink signal, a second indication to modify the transmission power of the uplink signal, or a combination thereof.

In some implementations, UE 115-b may determine to modify a transmission power used by UE 115-b to transmit the first message based on the indication. UE 115-b may select a communication beam for communicating the first message based on the indication included in the DCI message, where communicating the first message is based on selecting the communication beam.

At 620, UE 115-b may communicate the first message using the set of parameters associated with the full-duplex operation and based on the indication included in the DCI message. In some cases, such as if UE 115-b received the second DCI message, UE 115-b may communicate the second message based on the indication included in the second DCI message. To communicate the first message and the second message, UE 115-b may transit, to base station 105-b, the first message during a time interval based on the DCI message, and receive, from base station 105-b, the second message during the time interval based on the second DCI message.

In some implementations, UE 115-b may determine a failure by UE 115-b to receive a second DCI message scheduling a second message for the full-duplex operation with the first message, and UE 115-b may communicate the first message using the set of parameters and based on the indication included in the DCI message.

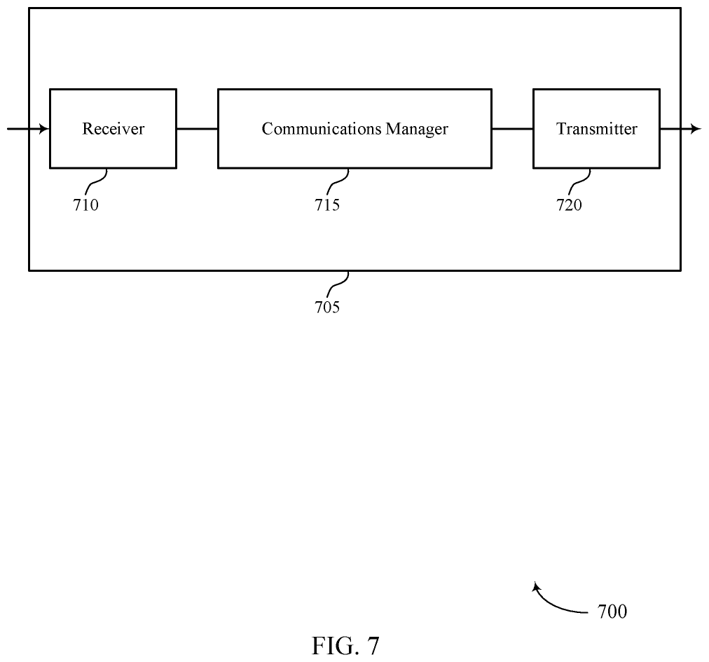

FIG. 7 shows a diagram 700 of a device 705 that supports dynamic full-duplex communication in accordance with aspects of the present disclosure. The device 705 may be an example of aspects of a UE 115 as described herein. The device 705 may include a receiver 710, a communications manager 715, and a transmitter 720. The device 705 may also include a processor. Each of these components may be in communication with one another (e.g., via one or more buses).

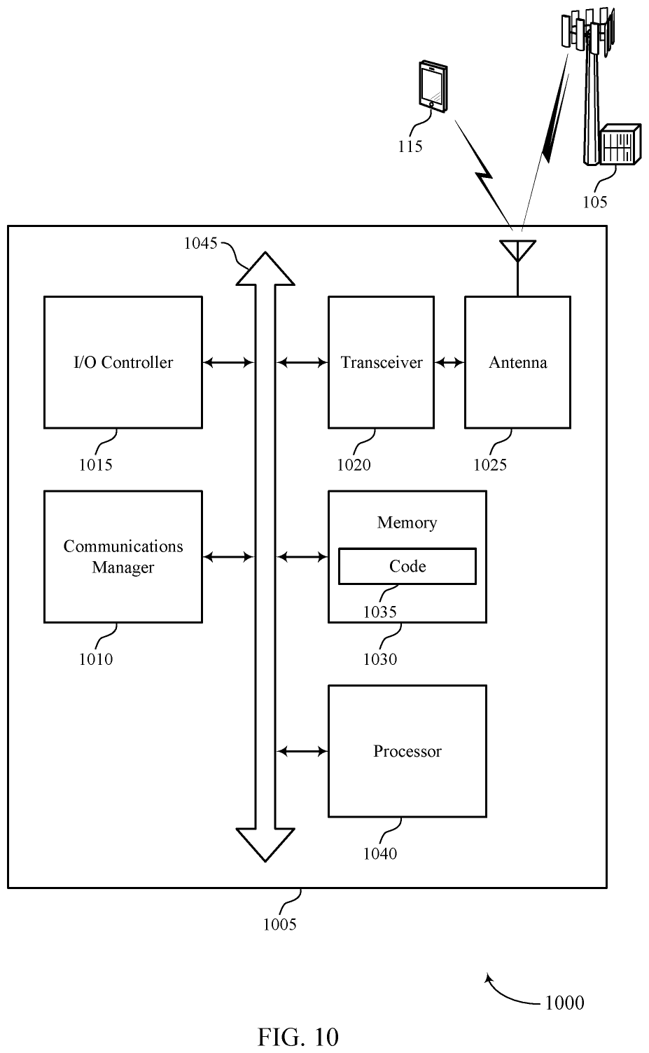

The receiver 710 may receive information such as packets, user data, or control information associated with various information channels (e.g., control channels, data channels, and information related to dynamic full-duplex communication, etc.). Information may be passed on to other components of the device 705. The receiver 710 may be an example of aspects of the transceiver 1020 described with reference to FIG. 10. The receiver 710 may utilize a single antenna or a set of antennas.

The communications manager 715 may receive, from a base station, a DCI message scheduling a first message and including an indication that the first message is scheduled for full-duplex operation, identify a set of parameters associated with the full-duplex operation of the first message based on receiving the DCI message that includes the indication, and communicate the first message using the set of parameters associated with the full-duplex operation and based on the indication included in the DCI message. The communications manager 715 may be an example of aspects of the communications manager 1010 described herein.

The communications manager 715, or its sub-components, may be implemented in hardware, code (e.g., software or firmware) executed by a processor, or any combination thereof. If implemented in code executed by a processor, the functions of the communications manager 715, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 715, or its sub-components, may be physically located at various positions, including being distributed such that portions of functions are implemented at different physical locations by one or more physical components. In some examples, the communications manager 715, or its sub-components, may be a separate and distinct component in accordance with various aspects of the present disclosure. In some examples, the communications manager 715, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 720 may transmit signals generated by other components of the device 705. In some examples, the transmitter 720 may be collocated with a receiver 710 in a transceiver module. For example, the transmitter 720 may be an example of aspects of the transceiver 1020 described with reference to FIG. 10. The transmitter 720 may utilize a single antenna or a set of antennas.

The communications manager 715 as described herein may be implemented to realize one or more potential advantages. One implementation may allow the device to more efficiently decode DCI, reserve processing resources, and more efficiently expend power. This may result in decreased power expenditures and improved battery life. Additionally, implementations may allow the device to more accurately determine transmission and reception parameters, resulting in improved efficiency in transmitting and receiving, decreased system delays, and the like.

Based on techniques for efficiently identifying and performing full-duplex operations for a device as described herein, a processor of a UE 115 (e.g., controlling the receiver 710, the transmitter 720, or a transceiver 1020 as described with respect to FIG. 10) may increase system efficiency and decrease unnecessary processing at a device.

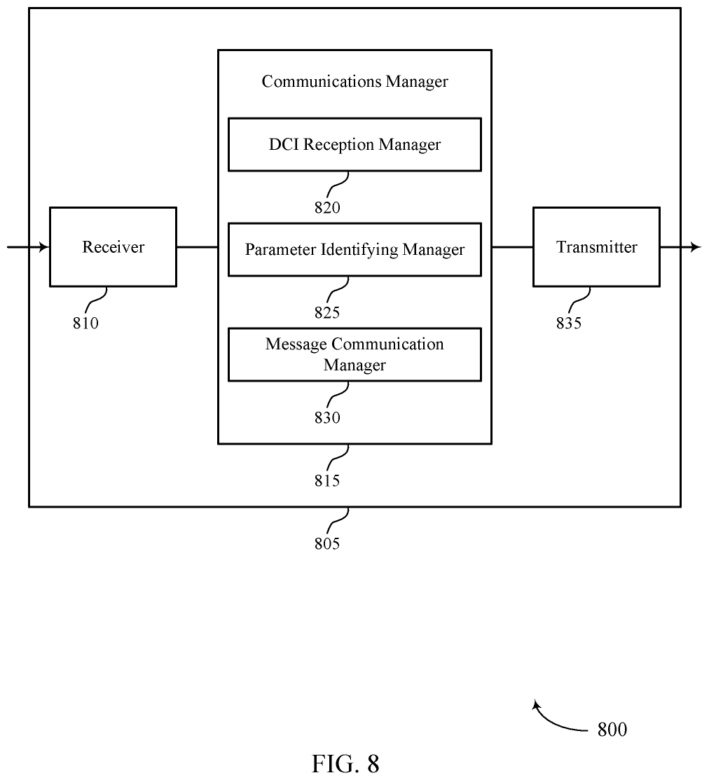

FIG. 8 shows a diagram 800 of a device 805 that supports dynamic full-duplex communication in accordance with aspects of the present disclosure. The device 805 may be an example of aspects of a device 705, or a UE 115 as described herein. The device 805 may include a receiver 810, a communications manager 815, and a transmitter 835. The device 805 may also include a processor. Each of these components may be in communication with one another (e.g., via one or more buses).

The receiver 810 may receive information such as packets, user data, or control information associated with various information channels (e.g., control channels, data channels, and information related to dynamic full-duplex communication, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815 may be an example of aspects of the communications manager 715 as described herein. The communications manager 815 may include a DCI reception manager 820, a parameter identifying manager 825, and a message communication manager 830. The communications manager 815 may be an example of aspects of the communications manager 1010 described herein.

The DCI reception manager 820 may receive, from a base station, a DCI message scheduling a first message and including an indication that the first message is scheduled for full-duplex operation. The parameter identifying manager 825 may identify a set of parameters associated with the full-duplex operation of the first message based on receiving the DCI message that includes the indication. The message communication manager 830 may communicate the first message using the set of parameters associated with the full-duplex operation and based on the indication included in the DCI message.

The transmitter 835 may transmit signals generated by other components of the device 805. In some examples, the transmitter 835 may be collocated with a receiver 810 in a transceiver module. For example, the transmitter 835 may be an example of aspects of the transceiver 1020 described with reference to FIG. 10. The transmitter 835 may utilize a single antenna or a set of antennas.

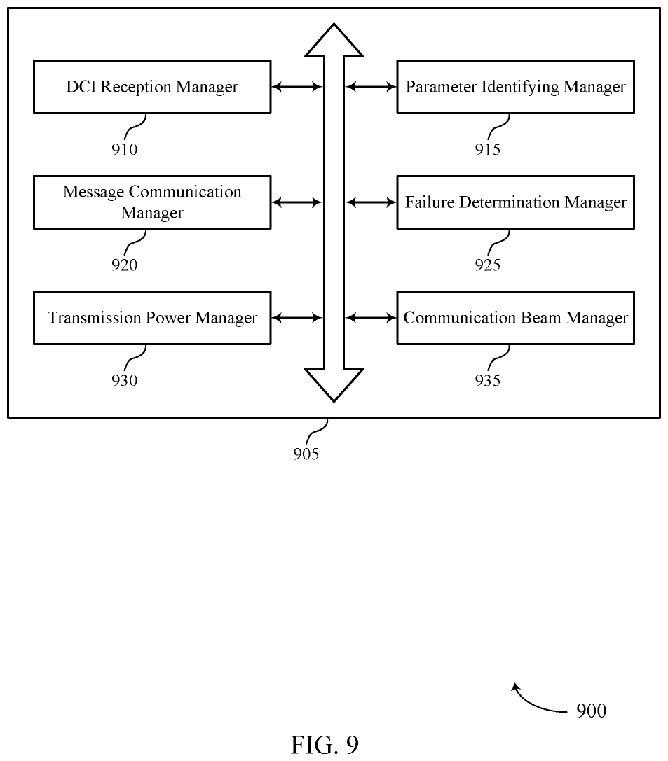

FIG. 9 shows a diagram 900 of a communications manager 905 that supports dynamic full-duplex communication in accordance with aspects of the present disclosure. The communications manager 905 may be an example of aspects of a communications manager 715, a communications manager 815, or a communications manager 1010 described herein. The communications manager 905 may include a DCI reception manager 910, a parameter identifying manager 915, a message communication manager 920, a failure determination manager 925, a transmission power manager 930, and a communication beam manager 935. Each of these modules may communicate, directly or indirectly, with one another (e.g., via one or more buses).

The DCI reception manager 910 may receive, from a base station, a DCI message scheduling a first message and including an indication that the first message is scheduled for full-duplex operation. The parameter identifying manager 915 may identify a set of parameters associated with the full-duplex operation of the first message based on receiving the DCI message that includes the indication. The message communication manager 920 may communicate the first message using the set of parameters associated with the full-duplex operation and based on the indication included in the DCI message.

In some examples, the DCI reception manager 910 may receive, from the base station, a second DCI message scheduling a second message and including a second indication that the second message is scheduled for the full-duplex operation with the first message. In some examples, the message communication manager 920 may communicate the second message based on the indication included in the second DCI message. In some examples, the message communication manager 920 may transmit, to the base station, the first message during a time interval based on the DCI message. In some examples, the message communication manager 920 may receive, from the base station, the second message during the time interval based on the second DCI message.

The failure determination manager 925 may determine a failure by the UE to receive a second DCI message scheduling a second message for the full-duplex operation with the first message. In some examples, the message communication manager 920 may communicate the first message using the set of parameters and based on the indication included in the DCI message.

In some cases, the indication includes one bit of a field in the DCI message, the one bit indicating whether the first message scheduled by the DCI message is communicated using a full-duplexing mode or a half-duplexing mode. In some cases, the indication includes a set of bits of a field of the DCI message, the set of bits indicating whether the first message scheduled by the DCI message is communicated using a full-duplexing mode or a half-duplexing mode, and information related to the full-duplexing mode or the half-duplexing mode. In some cases, the indication is included in a TCI state field of the DCI message or an MCS field of the DCI message.

In some cases, the set of parameters include one or more of MCS tables, TCI states, control resource sets, power control parameters, self-interference measurements, CLI measurements, puncturing parameters, rate matching parameters, uplink TA, a transmission power of an uplink signal, a second indication to modify the transmission power of the uplink signal, or a combination thereof.

In some cases, the indication includes a UE-specific indication, or the DCI message includes a UE-specific DCI message.

In some examples, the DCI reception manager 910 may receive the DCI message including the indication that the first message is scheduled to be communicated in a slot that is associated with full-duplexing.

The transmission power manager 930 may determine to modify a transmission power used by the UE to transmit the first message based on the indication.

In some cases, the UE is configured with a scheduling offset between receiving the DCI message and communicating the first message above a threshold, the scheduling offset including a number of symbols from an end of the DCI message to a start of the first message.

In some cases, the UE receives the DCI message on a first carrier and the DCI message indicates scheduling the first message on a second carrier, the DCI message indicating inter-cell full-duplexing or half-duplexing.

In some cases, the UE receives the DCI message on a first carrier and the DCI message indicates scheduling the first message on the first carrier during a time interval and indicates scheduling a second message on a second carrier during the time interval. In some cases, the first message is an uplink transmission and the second message is a downlink transmission, or vice versa.

In some cases, the UE receives the DCI message on a downlink frequency band and the DCI message indicates scheduling the first message on the first downlink frequency band during a time interval and indicates scheduling a second message on an uplink frequency band during the time interval, or vice versa.

The communication beam manager 935 may select a communication beam for communicating the first message based on the indication included in the DCI message, where communicating the first message is based on selecting the communication beam.

FIG. 10 shows a diagram of a system 1000 including a device 1005 that supports dynamic full-duplex communication in accordance with aspects of the present disclosure. The device 1005 may be an example of or include the components of device 705, device 805, or a UE 115 as described herein. The device 1005 may include components for bi-directional voice and data communications including components for transmitting and receiving communications, including a communications manager 1010, an I/O controller 1015, a transceiver 1020, an antenna 1025, memory 1030, and a processor 1040. These components may be in electronic communication via one or more buses (e.g., bus 1045).

The communications manager 1010 may receive, from a base station, a DCI message scheduling a first message and including an indication that the first message is scheduled for full-duplex operation, identify a set of parameters associated with the full-duplex operation of the first message based on receiving the DCI message that includes the indication, and communicate the first message using the set of parameters associated with the full-duplex operation and based on the indication included in the DCI message.

The I/O controller 1015 may manage input and output signals for the device 1005. The I/O controller 1015 may also manage peripherals not integrated into the device 1005. In some cases, the I/O controller 1015 may represent a physical connection or port to an external peripheral. In some cases, the I/O controller 1015 may utilize an operating system such as iOS®, ANDROID®, MS-DOS®, MS-WINDOWS®, OS/2®, UNIX®, LINUX®, or another known operating system. In other cases, the I/O controller 1015 may represent or interact with a modem, a keyboard, a mouse, a touchscreen, or a similar device. In some cases, the I/O controller 1015 may be implemented as part of a processor. In some cases, a user may interact with the device 1005 via the I/O controller 1015 or via hardware components controlled by the I/O controller 1015.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include random-access memory (RAM) and read-only memory (ROM). The memory 1030 may store computer-readable, computer-executable code 1035 including instructions that, when executed, cause the processor to perform various functions described herein. In some cases, the memory 1030 may contain, among other things, a basic I/O system (BIOS) which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting dynamic full-duplex communication).

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

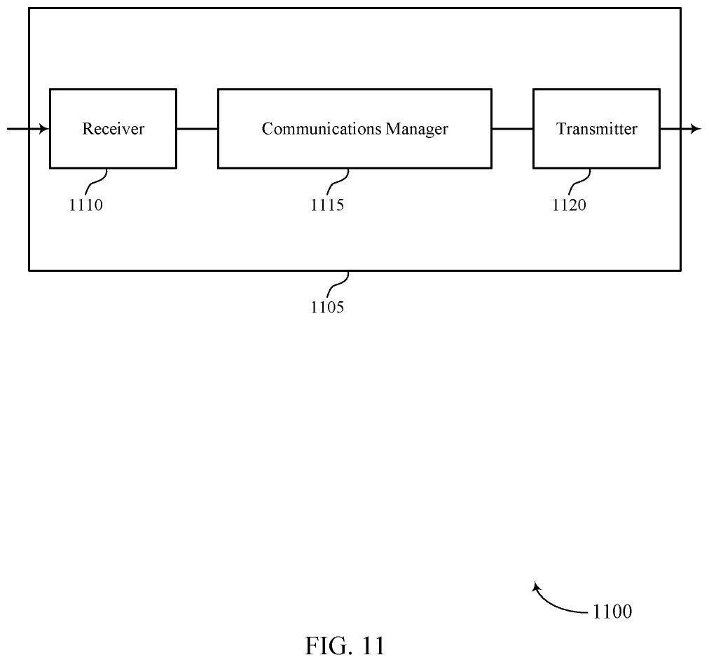

FIG. 11 shows a diagram 1100 of a device 1105 that supports dynamic full-duplex communication in accordance with aspects of the present disclosure. The device 1105 may be an example of aspects of a base station 105 as described herein. The device 1105 may include a receiver 1110, a communications manager 1115, and a transmitter 1120. The device 1105 may also include a processor. Each of these components may be in communication with one another (e.g., via one or more buses).

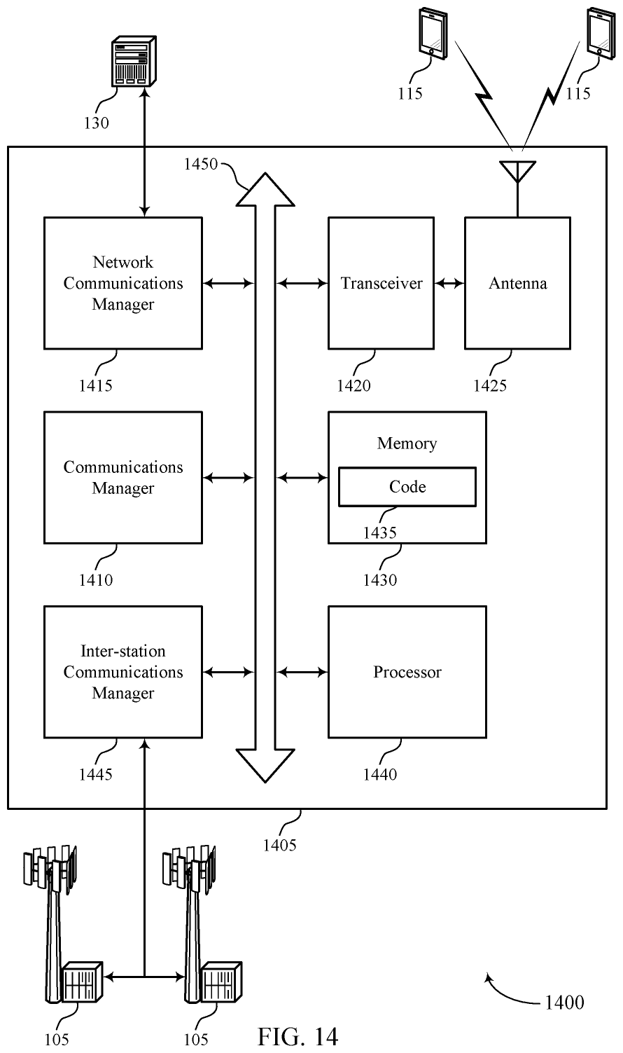

The receiver 1110 may receive information such as packets, user data, or control information associated with various information channels (e.g., control channels, data channels, and information related to dynamic full-duplex communication, etc.). Information may be passed on to other components of the device 1105. The receiver 1110 may be an example of aspects of the transceiver 1420 described with reference to FIG. 14. The receiver 1110 may utilize a single antenna or a set of antennas.

The communications manager 1115 may determine to schedule a first message for full-duplex operation with a second message, transmit, to a UE, a DCI message scheduling the first message and including an indication that the first message is scheduled for the full-duplex operation based on the determination, and communicate the first message using a set of parameters associated with the full-duplex operation based on the indication included in the DCI message. The communications manager 1115 may be an example of aspects of the communications manager 1410 described herein.

The communications manager 1115, or its sub-components, may be implemented in hardware, code (e.g., software or firmware) executed by a processor, or any combination thereof. If implemented in code executed by a processor, the functions of the communications manager 1115, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 1115, or its sub-components, may be physically located at various positions, including being distributed such that portions of functions are implemented at different physical locations by one or more physical components. In some examples, the communications manager 1115, or its sub-components, may be a separate and distinct component in accordance with various aspects of the present disclosure. In some examples, the communications manager 1115, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1120 may transmit signals generated by other components of the device 1105. In some examples, the transmitter 1120 may be collocated with a receiver 1110 in a transceiver module. For example, the transmitter 1120 may be an example of aspects of the transceiver 1420 described with reference to FIG. 14. The transmitter 1120 may utilize a single antenna or a set of antennas.

The communications manager 1115 as described herein may be implemented to realize one or more potential advantages. One implementation may allow the device to more efficiently decode DCI, reserve processing resources, and more efficiently expend power. This may result in decreased power expenditures and improved battery life. Additionally, implementations may allow the device to more accurately determine transmission and reception parameters, resulting in improved efficiency in transmitting and receiving, decreased system delays, and the like.

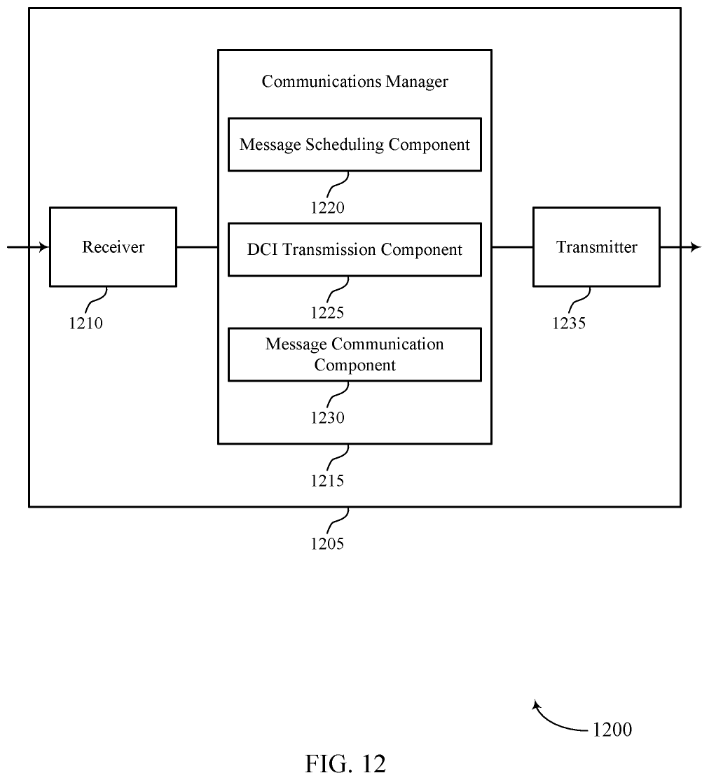

FIG. 12 shows a diagram 1200 of a device 1205 that supports dynamic full-duplex communication in accordance with aspects of the present disclosure. The device 1205 may be an example of aspects of a device 1105, or a base station 105 as described herein. The device 1205 may include a receiver 1210, a communications manager 1215, and a transmitter 1235. The device 1205 may also include a processor. Each of these components may be in communication with one another (e.g., via one or more buses).

The receiver 1210 may receive information such as packets, user data, or control information associated with various information channels (e.g., control channels, data channels, and information related to dynamic full-duplex communication, etc.). Information may be passed on to other components of the device 1205. The receiver 1210 may be an example of aspects of the transceiver 1420 described with reference to FIG. 14. The receiver 1210 may utilize a single antenna or a set of antennas.

The communications manager 1215 may be an example of aspects of the communications manager 1115 as described herein. The communications manager 1215 may include a message scheduling component 1220, a DCI transmission component 1225, and a message communication component 1230. The communications manager 1215 may be an example of aspects of the communications manager 1410 described herein.

The message scheduling component 1220 may determine to schedule a first message for full-duplex operation with a second message. The DCI transmission component 1225 may transmit, to a UE, a DCI message scheduling the first message and including an indication that the first message is scheduled for the full-duplex operation based on the determination. The message communication component 1230 may communicate the first message using a set of parameters associated with the full-duplex operation based on the indication included in the DCI message.

The transmitter 1235 may transmit signals generated by other components of the device 1205. In some examples, the transmitter 1235 may be collocated with a receiver 1210 in a transceiver module. For example, the transmitter 1235 may be an example of aspects of the transceiver 1420 described with reference to FIG. 14. The transmitter 1235 may utilize a single antenna or a set of antennas.

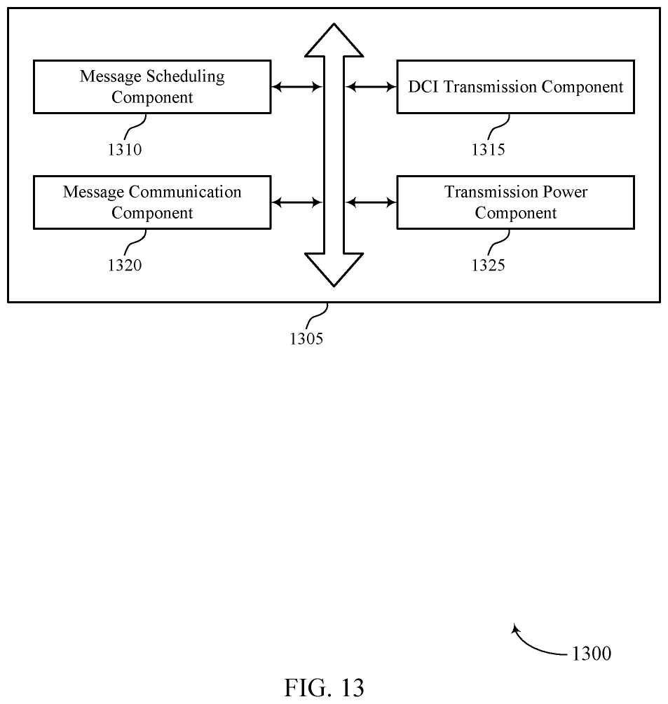

FIG. 13 shows a diagram 1300 of a communications manager 1305 that supports dynamic full-duplex communication in accordance with aspects of the present disclosure. The communications manager 1305 may be an example of aspects of a communications manager 1115, a communications manager 1215, or a communications manager 1410 described herein. The communications manager 1305 may include a message scheduling component 1310, a DCI transmission component 1315, a message communication component 1320, and a transmission power component 1325. Each of these modules may communicate, directly or indirectly, with one another (e.g., via one or more buses).

The message scheduling component 1310 may determine to schedule a first message for full-duplex operation with a second message. The DCI transmission component 1315 may transmit, to a UE, a DCI message scheduling the first message and including an indication that the first message is scheduled for the full-duplex operation based on the determination. The message communication component 1320 may communicate the first message using a set of parameters associated with the full-duplex operation based on the indication included in the DCI message.

In some examples, the DCI transmission component 1315 may transmit, to the UE, a second DCI message scheduling the second message and including a second indication that the second message is scheduled for the full-duplex operation with the first message. In some examples, the message communication component 1320 may communicate the second message based on the indication included in the second DCI message. In some examples, the message communication component 1320 may receive, from the UE, the first message during a time interval based on the DCI message. In some examples, the message communication component 1320 may transmit, to the UE, the second message during the time interval based on the second DCI message.

In some cases, the indication includes one bit of a field in the DCI message, the one bit indicating whether the first message scheduled by the DCI message is communicated using a full-duplexing mode or a half-duplexing mode. In some cases, the indication includes a set of bits of a field of the DCI message, the set of bits indicating whether the first message scheduled by the DCI message is communicated using a full-duplexing mode or a half-duplexing mode, and information related to the full-duplexing mode or the half-duplexing mode. In some cases, the indication is included in a TCI state field of the DCI message or an MCS field of the DCI message.

In some cases, the set of parameters include one or more of MCS tables, TCI states, control resource sets, power control parameters, self-interference measurements, CLI measurements, puncturing parameters, rate matching parameters, uplink TA, a transmission power of an uplink signal, a second indication to modify the transmission power of the uplink signal, or a combination thereof

In some cases, the indication includes a UE-specific indication, or the DCI message includes a UE-specific DCI message.

In some examples, the DCI transmission component 1315 may transmit the DCI message including the indication that the first message is scheduled to be communicated in a slot that is associated with full-duplexing.

The transmission power component 1325 may determine to include, in the indication, instructions for the UE to modify a transmission power used by the UE to transmit the first message.

In some cases, the base station transmits the DCI message on a first carrier and the DCI message indicates scheduling the first message on a second carrier, the DCI message indicating inter-cell full-duplexing or half-duplexing.

In some cases, the base station transmits the DCI message on a first carrier and the DCI message indicates scheduling the first message on the first carrier during a time interval and indicates scheduling a second message on a second carrier during the time interval. In some cases, the first message is an uplink transmission and the second message is a downlink transmission, or vice versa.

In some cases, the base station transmits the DCI message on a downlink frequency band and the DCI message indicates scheduling the first message on the first downlink frequency band during a time interval and indicates scheduling a second message on an uplink frequency band during the time interval, or vice versa.

In some cases, the base station is configured with a scheduling offset between transmitting the DCI message and communicating the first message above a threshold, the scheduling offset including a number of symbols from an end of the DCI message to a start of the first message.

FIG. 14 shows a diagram of a system 1400 including a device 1405 that supports dynamic full-duplex communication in accordance with aspects of the present disclosure. The device 1405 may be an example of or include the components of device 1105, device 1205, or a base station 105 as described herein. The device 1405 may include components for bi-directional voice and data communications including components for transmitting and receiving communications, including a communications manager 1410, a network communications manager 1415, a transceiver 1420, an antenna 1425, memory 1430, a processor 1440, and an inter-station communications manager 1445. These components may be in electronic communication via one or more buses (e.g., bus 1450).

The communications manager 1410 may determine to schedule a first message for full-duplex operation with a second message, transmit, to a UE, a DCI message scheduling the first message and including an indication that the first message is scheduled for the full-duplex operation based on the determination, and communicate the first message using a set of parameters associated with the full-duplex operation based on the indication included in the DCI message.

The network communications manager 1415 may manage communications with the core network (e.g., via one or more wired backhaul links). For example, the network communications manager 1415 may manage the transfer of data communications for client devices, such as one or more UEs 115.

The transceiver 1420 may communicate bi-directionally, via one or more antennas, wired, or wireless links as described above. For example, the transceiver 1420 may represent a wireless transceiver and may communicate bi-directionally with another wireless transceiver. The transceiver 1420 may also include a modem to modulate the packets and provide the modulated packets to the antennas for transmission, and to demodulate packets received from the antennas.

In some cases, the wireless device may include a single antenna 1425. However, in some cases the device may have more than one antenna 1425, which may be capable of concurrently transmitting or receiving multiple wireless transmissions.

The memory 1430 may include RAM, ROM, or a combination thereof. The memory 1430 may store computer-readable code 1435 including instructions that, when executed by a processor (e.g., the processor 1440) cause the device to perform various functions described herein. In some cases, the memory 1430 may contain, among other things, a BIOS which may control basic hardware or software operation such as the interaction with peripheral components or devices.

The processor 1440 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some cases, a memory controller may be integrated into processor 1440. The processor 1440 may be configured to execute computer-readable instructions stored in a memory (e.g., the memory 1430) to cause the device 1405 to perform various functions (e.g., functions or tasks supporting dynamic full-duplex communication).

The inter-station communications manager 1445 may manage communications with other base station 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communication network technology to provide communication between base stations 105.

The code 1435 may include instructions to implement aspects of the present disclosure, including instructions to support wireless communications. The code 1435 may be stored in a non-transitory computer-readable medium such as system memory or other type of memory. In some cases, the code 1435 may not be directly executable by the processor 1440 but may cause a computer (e.g., when compiled and executed) to perform functions described herein.

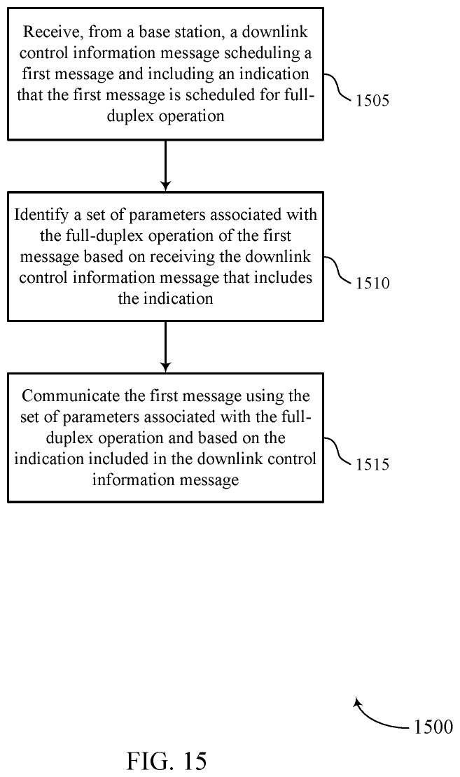

FIG. 15 shows a flowchart illustrating a method 1500 that supports dynamic full-duplex communication in accordance with aspects of the present disclosure. The operations of method 1500 may be implemented by a UE 115 or its components as described herein. For example, the operations of method 1500 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1505, the UE may receive, from a base station, a DCI message scheduling a first message and including an indication that the first message is scheduled for full-duplex operation. The operations of 1505 may be performed according to the methods described herein. In some examples, aspects of the operations of 1505 may be performed by a DCI reception manager as described with reference to FIGS. 7 through 10.

At 1510, the UE may identify a set of parameters associated with the full-duplex operation of the first message based on receiving the DCI message that includes the indication. The operations of 1510 may be performed according to the methods described herein. In some examples, aspects of the operations of 1510 may be performed by a parameter identifying manager as described with reference to FIGS. 7 through 10.

At 1515, the UE may communicate the first message using the set of parameters associated with the full-duplex operation and based on the indication included in the DCI message. The operations of 1515 may be performed according to the methods described herein. In some examples, aspects of the operations of 1515 may be performed by a message communication manager as described with reference to FIGS. 7 through 10.

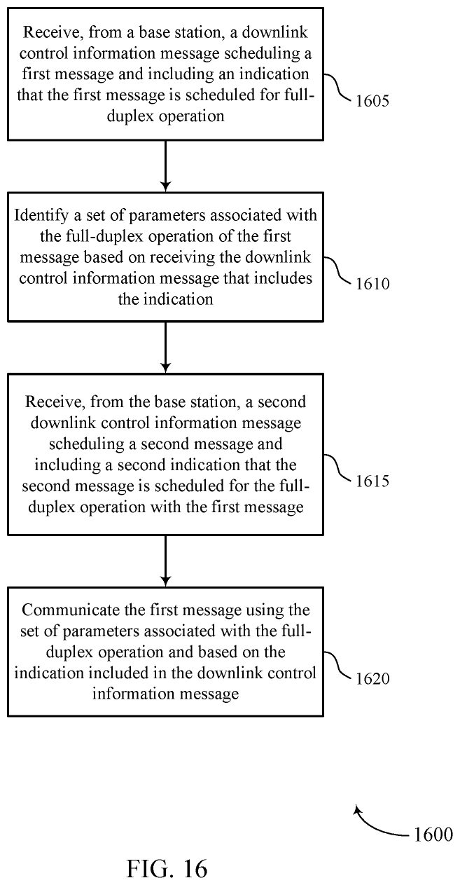

FIG. 16 shows a flowchart illustrating a method 1600 that supports dynamic full-duplex communication in accordance with aspects of the present disclosure. The operations of method 1600 may be implemented by a UE 115 or its components as described herein. For example, the operations of method 1600 may be performed by a communications manager as described with reference to FIGS. 7 through 10. In some examples, a UE may execute a set of instructions to control the functional elements of the UE to perform the functions described below. Additionally or alternatively, a UE may perform aspects of the functions described below using special-purpose hardware.

At 1605, the UE may receive, from a base station, a DCI message scheduling a first message and including an indication that the first message is scheduled for full-duplex operation. The operations of 1605 may be performed according to the methods described herein. In some examples, aspects of the operations of 1605 may be performed by a DCI reception manager as described with reference to FIGS. 7 through 10.

At 1610, the UE may identify a set of parameters associated with the full-duplex operation of the first message based on receiving the DCI message that includes the indication. The operations of 1610 may be performed according to the methods described herein. In some examples, aspects of the operations of 1610 may be performed by a parameter identifying manager as described with reference to FIGS. 7 through 10.

At 1615, the UE may receive, from the base station, a second DCI message scheduling a second message and including a second indication that the second message is scheduled for the full-duplex operation with the first message. The operations of 1615 may be performed according to the methods described herein. In some examples, aspects of the operations of 1615 may be performed by a DCI reception manager as described with reference to FIGS. 7 through 10.

At 1620, the UE may communicate the first message using the set of parameters associated with the full-duplex operation and based on the indication included in the DCI message. The operations of 1620 may be performed according to the methods described herein. In some examples, aspects of the operations of 1620 may be performed by a message communication manager as described with reference to FIGS. 7 through 10.

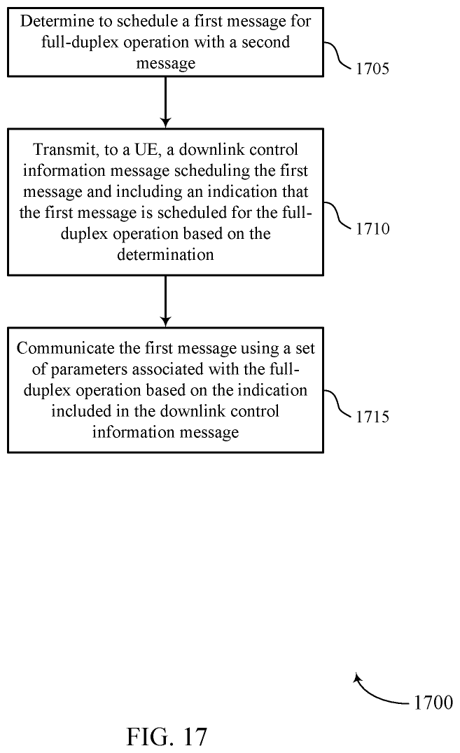

FIG. 17 shows a flowchart illustrating a method 1700 that supports dynamic full-duplex communication in accordance with aspects of the present disclosure. The operations of method 1700 may be implemented by a base station 105 or its components as described herein. For example, the operations of method 1700 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1705, the base station may determine to schedule a first message for full-duplex operation with a second message. The operations of 1705 may be performed according to the methods described herein. In some examples, aspects of the operations of 1705 may be performed by a message scheduling component as described with reference to FIGS. 11 through 14.

At 1710, the base station may transmit, to a UE, a DCI message scheduling the first message and including an indication that the first message is scheduled for the full-duplex operation based on the determination. The operations of 1710 may be performed according to the methods described herein. In some examples, aspects of the operations of 1710 may be performed by a DCI transmission component as described with reference to FIGS. 11 through 14.

At 1715, the base station may communicate the first message using a set of parameters associated with the full-duplex operation based on the indication included in the DCI message. The operations of 1715 may be performed according to the methods described herein. In some examples, aspects of the operations of 1715 may be performed by a message communication component as described with reference to FIGS. 11 through 14.

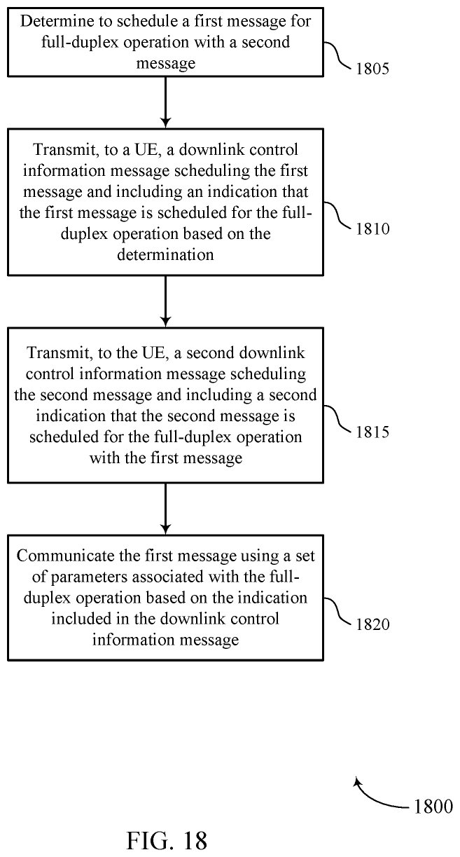

FIG. 18 shows a flowchart illustrating a method 1800 that supports dynamic full-duplex communication in accordance with aspects of the present disclosure. The operations of method 1800 may be implemented by a base station 105 or its components as described herein. For example, the operations of method 1800 may be performed by a communications manager as described with reference to FIGS. 11 through 14. In some examples, a base station may execute a set of instructions to control the functional elements of the base station to perform the functions described below. Additionally or alternatively, a base station may perform aspects of the functions described below using special-purpose hardware.

At 1805, the base station may determine to schedule a first message for full-duplex operation with a second message. The operations of 1805 may be performed according to the methods described herein. In some examples, aspects of the operations of 1805 may be performed by a message scheduling component as described with reference to FIGS. 11 through 14.

At 1810, the base station may transmit, to a UE, a DCI message scheduling the first message and including an indication that the first message is scheduled for the full-duplex operation based on the determination. The operations of 1810 may be performed according to the methods described herein. In some examples, aspects of the operations of 1810 may be performed by a DCI transmission component as described with reference to FIGS. 11 through 14.

At 1815, the base station may transmit, to the UE, a second DCI message scheduling the second message and including a second indication that the second message is scheduled for the full-duplex operation with the first message. The operations of 1815 may be performed according to the methods described herein. In some examples, aspects of the operations of 1815 may be performed by a DCI transmission component as described with reference to FIGS. 11 through 14.

At 1820, the base station may communicate the first message using a set of parameters associated with the full-duplex operation based on the indication included in the DCI message. The operations of 1820 may be performed according to the methods described herein. In some examples, aspects of the operations of 1820 may be performed by a message communication component as described with reference to FIGS. 11 through 14.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a UE, comprising: receiving, from a base station, a downlink control information message scheduling a first message and comprising an indication that the first message is scheduled for full-duplex operation; identifying a set of parameters associated with the full-duplex operation of the first message based at least in part on receiving the downlink control information message that includes the indication; and communicating the first message using the set of parameters associated with the full-duplex operation and based at least in part on the indication included in the downlink control information message.

Aspect 2: The method of aspect 1, further comprising: receiving, from the base station, a second downlink control information message scheduling a second message and comprising a second indication that the second message is scheduled for the full-duplex operation with the first message.

Aspect 3: The method of aspect 2, further comprising: communicating the second message based at least in part on the indication included in the second downlink control information message.

Aspect 4: The method of aspect 3, wherein communicating the first message and communicating the second message further comprises: transmitting, to the base station, the first message during a time interval based at least in part on the downlink control information message; and receiving, from the base station, the second message during the time interval based at least in part on the second downlink control information message.

Aspect 5: The method of any of aspects 1 through 4, further comprising: determining a failure by the UE to receive a second downlink control information message scheduling a second message for the full-duplex operation with the first message; and communicating the first message using the set of parameters and based at least in part on the indication included in the downlink control information message.

Aspect 6: The method of any of aspects 1 through 5, wherein the indication comprises one bit of a field in the downlink control information message, the one bit indicating whether the first message scheduled by the downlink control information message is communicated using a full-duplexing mode or a half-duplexing mode.

Aspect 7: The method of any of aspects 1 through 6, wherein the indication comprises a plurality of bits of a field of the downlink control information message, the plurality of bits indicating whether the first message scheduled by the downlink control information message is communicated using a full-duplexing mode or a half-duplexing mode, and information related to the full-duplexing mode or the half-duplexing mode.

Aspect 8: The method of any of aspects 1 through 7, wherein the indication is included in a transmission configuration indicator state field of the downlink control information message or a modulation and coding scheme field of the downlink control information message.

Aspect 9: The method of any of aspects 1 through 8, wherein the set of parameters comprise one or more of modulation and coding scheme tables, transmission configuration indicator states, control resource sets, power control parameters, self-interference measurements, cross-link interference measurements, puncturing parameters, rate matching parameters, uplink timing advance, a transmission power of an uplink signal, a second indication to modify the transmission power of the uplink signal, or a combination thereof

Aspect 10: The method of any of aspects 1 through 9, wherein the indication comprises a UE-specific indication; or the downlink control information message comprises a UE-specific downlink control information message.

Aspect 11: The method of any of aspects 1 through 10, wherein receiving the downlink control information message further comprises: receiving the downlink control information message comprising the indication that the first message is scheduled to be communicated in a slot that is associated with full-duplexing.

Aspect 12: The method of any of aspects 1 through 11, further comprising: determining to modify a transmission power used by the UE to transmit the first message based at least in part on the indication.

Aspect 13: The method of any of aspects 1 through 12, wherein the UE is configured with a scheduling offset between receiving the downlink control information message and communicating the first message above a threshold, the scheduling offset comprising a number of symbols from an end of the downlink control information message to a start of the first message.

Aspect 14: The method of any of aspects 1 through 13, wherein the UE receives the downlink control information message on a first carrier and the downlink control information message indicates scheduling the first message on a second carrier, the downlink control information message indicating inter-cell full-duplexing or half-duplexing.

Aspect 15: The method of any of aspects 1 through 14, wherein the UE receives the downlink control information message on a first carrier and the downlink control information message indicates scheduling the first message on the first carrier during a time interval and indicates scheduling a second message on a second carrier during the time interval.

Aspect 16: The method of aspect 15, wherein the first message is an uplink transmission and the second message is a downlink transmission, or vice versa.

Aspect 17: The method of any of aspects 1 through 16, wherein the UE receives the downlink control information message on a downlink frequency band and the downlink control information message indicates scheduling the first message on the downlink frequency band during a time interval and indicates scheduling a second message on an uplink frequency band during the time interval, or vice versa.

Aspect 18: The method of any of aspects 1 through 17, further comprising: selecting a communication beam for communicating the first message based at least in part on the indication included in the downlink control information message, wherein communicating the first message is based at least in part on selecting the communication beam.

Aspect 19: A method for wireless communications at a base station, comprising: determining to schedule a first message for full-duplex operation with a second message; transmitting, to a UE, a downlink control information message scheduling the first message and comprising an indication that the first message is scheduled for the full-duplex operation based at least in part on the determination; and communicating the first message using a set of parameters associated with the full-duplex operation based at least in part on the indication included in the downlink control information message.

Aspect 20: The method of aspect 19, further comprising: transmitting, to the UE, a second downlink control information message scheduling the second message and comprising a second indication that the second message is scheduled for the full-duplex operation with the first message.

Aspect 21: The method of aspect 20, further comprising: communicating the second message based at least in part on the indication included in the second downlink control information message.

Aspect 22: The method of aspect 21, wherein communicating the first message and communicating the second message further comprises: receiving, from the UE, the first message during a time interval based at least in part on the downlink control information message; and transmitting, to the UE, the second message during the time interval based at least in part on the second downlink control information message.

Aspect 23: The method of any of aspects 19 through 22, wherein the indication comprises one bit of a field in the downlink control information message, the one bit indicating whether the first message scheduled by the downlink control information message is communicated using a full-duplexing mode or a half-duplexing mode.

Aspect 24: The method of any of aspects 19 through 23, wherein the indication is included in a transmission configuration indicator state field of the downlink control information message or a modulation and coding scheme field of the downlink control information message.

Aspect 25: The method of any of aspects 19 through 24, wherein the set of parameters comprise one or more of modulation and coding scheme tables, transmission configuration indicator states, control resource sets, power control parameters, self-interference measurements, cross-link interference measurements, puncturing parameters, rate matching parameters, uplink timing advance, a transmission power of an uplink signal, a second indication to modify the transmission power of the uplink signal, or a combination thereof.

Aspect 26: The method of any of aspects 19 through 25, wherein the indication comprises a UE-specific indication; or the downlink control information message comprises a UE-specific downlink control information message.

Aspect 27: The method of any of aspects 19 through 26, wherein transmitting the downlink control information message further comprises: transmitting the downlink control information message comprising the indication that the first message is scheduled to be communicated in a slot that is associated with full-duplexing.

Aspect 28: The method of any of aspects 19 through 27, further comprising: determining to include, in the indication, instructions for the UE to modify a transmission power used by the UE to transmit the first message.

Aspect 29: The method of any of aspects 19 through 28, wherein the base station is configured with a scheduling offset between transmitting the downlink control information message and communicating the first message above a threshold, the scheduling offset comprising a number of symbols from an end of the downlink control information message to a start of the first message.

Aspect 30: The method of any of aspects 19 through 29, wherein the base station transmits the downlink control information message on a first carrier and the downlink control information message indicates scheduling the first message on a second carrier, the downlink control information message indicating inter-cell full-duplexing or half-duplexing.

Aspect 31: The method of any of aspects 19 through 30, wherein the base station transmits the downlink control information message on a first carrier and the downlink control information message indicates scheduling the first message on the first carrier during a time interval and indicates scheduling a second message on a second carrier during the time interval.

Aspect 32: The method of aspect 31, wherein the first message is an uplink transmission and the second message is a downlink transmission, or vice versa.

Aspect 33: The method of any of aspects 19 through 32, wherein the base station transmits the downlink control information message on a downlink frequency band and the downlink control information message indicates scheduling the first message on the first downlink frequency band during a time interval and indicates scheduling a second message on an uplink frequency band during the time interval, or vice versa.

Aspect 34: The method of claim 0 wherein the indication comprises a plurality of bits of a field of the downlink control information message, the plurality of bits indicating whether the first message scheduled by the downlink control information message is communicated using a full-duplexing mode or a half-duplexing mode, and information related to the full-duplexing mode or the half-duplexing mode.

Aspect 35: An apparatus for wireless communications at a UE, comprising a processor; memory coupled with the processor; and instructions stored in the memory and executable by the processor to cause the apparatus to perform a method of any of aspects 1 through 18.

Aspect 36: An apparatus for wireless communications at a UE, comprising at least one means for performing a method of any of aspects 1 through 18.

Aspect 37: A non-transitory computer-readable medium storing code for wireless communications at a UE, the code comprising instructions executable by a processor to perform a method of any of aspects 1 through 18.

Aspect 38: An apparatus for wireless communications at a base station, comprising a processor; memory coupled with the processor; and instructions stored in the memory and executable by the processor to cause the apparatus to perform a method of any of aspects 19 through 33.

Aspect 39: An apparatus for wireless communications at a base station, comprising at least one means for performing a method of any of aspects 19 through 33.

Aspect 40: A non-transitory computer-readable medium storing code for wireless communications at a base station, the code comprising instructions executable by a processor to perform a method of any of aspects 19 through 33.

Aspect 41: An apparatus comprising a processor; memory coupled with the processor; and instructions stored in the memory and executable by the processor to cause the apparatus to perform a method of any of aspects 34 through 34.

Aspect 42: An apparatus comprising at least one means for performing a method of any of aspects 34 through 34.

Aspect 43: A non-transitory computer-readable medium storing code the code comprising instructions executable by a processor to perform a method of any of aspects 34 through 34.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications at a user equipment (UE), comprising:
a processor,
memory coupled with the processor; and
instructions stored in the memory and executable by the processor to cause the apparatus to:
receive, from a base station, a downlink control information message scheduling a first message and comprising an indication that the first message is scheduled for full-duplex operation;
identify a set of parameters associated with the full-duplex operation of the first message based at least in part on receiving the downlink control information message that includes the indication; and
communicate the first message using the set of parameters associated with the full-duplex operation and based at least in part on the indication included in the downlink control information message.

2. The apparatus of claim 1, wherein the instructions are further executable by the processor to cause the apparatus to:
receive, from the base station, a second downlink control information message scheduling a second message and comprising a second indication that the second message is scheduled for the full-duplex operation with the first message.

3. The apparatus of claim 2, wherein the instructions are further executable by the processor to cause the apparatus to:
communicate the second message based at least in part on the indication included in the second downlink control information message.

4. The apparatus of claim 3, wherein the instructions to communicate the first message and communicating the second message further are executable by the processor to cause the apparatus to:
transmit, to the base station, the first message during a time interval based at least in part on the downlink control information message; and
receive, from the base station, the second message during the time interval based at least in part on the second downlink control information message.

5. The apparatus of claim 1, wherein the instructions are further executable by the processor to cause the apparatus to:
determine a failure by the UE to receive a second downlink control information message scheduling a second message for the full-duplex operation with the first message; and
communicate the first message using the set of parameters and based at least in part on the indication included in the downlink control information message.

6. The apparatus of claim 1, wherein the indication comprises one bit of a field in the downlink control information message, the one bit indicating whether the first message scheduled by the downlink control information message is communicated using a full-duplexing mode or a half-duplexing mode.

7. The apparatus of claim 1, wherein the indication comprises a plurality of bits of a field of the downlink control information message, the plurality of bits indicating whether the first message scheduled by the downlink control information message is communicated using a full-duplexing mode or a half-duplexing mode, and information related to the full-duplexing mode or the half-duplexing mode.

8. The apparatus of claim 1, wherein the indication is included in a transmission configuration indicator state field of the downlink control information message or a modulation and coding scheme field of the downlink control information message.

9. The apparatus of claim 1, wherein the set of parameters comprise one or more of modulation and coding scheme tables, transmission configuration indicator states, control resource sets, power control parameters, self-interference measurements, cross-link interference measurements, puncturing parameters, rate matching parameters, uplink timing advance, a transmission power of an uplink signal, a second indication to modify the transmission power of the uplink signal, or a combination thereof.

10. The apparatus of claim 1, wherein:
the indication comprises a UE-specific indication; or
the downlink control information message comprises a UE-specific downlink control information message.

11. The apparatus of claim 1, wherein the instructions to receive the downlink control information message further are executable by the processor to cause the apparatus to:
receive the downlink control information message comprising the indication that the first message is scheduled to be communicated in a slot that is associated with full-duplexing.

12. The apparatus of claim 1, wherein the instructions are further executable by the processor to cause the apparatus to:
determine to modify a transmission power used by the UE to transmit the first message based at least in part on the indication.

13. The apparatus of claim 1, wherein the UE is configured with a scheduling offset between receiving the downlink control information message and communicating the first message above a threshold, the scheduling offset comprising a number of symbols from an end of the downlink control information message to a start of the first message.

14. The apparatus of claim 1, wherein the UE receives the downlink control information message on a first carrier and the downlink control information message indicates scheduling the first message on a second carrier, the downlink control information message indicating inter-cell full-duplexing or half-duplexing.

15. The apparatus of claim 1, wherein the UE receives the downlink control information message on a first carrier and the downlink control information message indicates scheduling the first message on the first carrier during a time interval and indicates scheduling a second message on a second carrier during the time interval.

16. The apparatus of claim 1, wherein the UE receives the downlink control information message on a downlink frequency band and the downlink control information message indicates scheduling the first message on the downlink frequency band during a time interval and indicates scheduling a second message on an uplink frequency band during the time interval, or vice versa.

17. The apparatus of claim 1, wherein the instructions are further executable by the processor to cause the apparatus to:
select a communication beam for communicating the first message based at least in part on the indication included in the downlink control information message, wherein communicating the first message is based at least in part on selecting the communication beam.

18. An apparatus for wireless communications at a base station, comprising:
a processor,
memory coupled with the processor; and
instructions stored in the memory and executable by the processor to cause the apparatus to:
determine to schedule a first message for full-duplex operation with a second message;
transmit, to a user equipment (UE), a downlink control information message scheduling the first message and comprising an indication that the first message is scheduled for the full-duplex operation based at least in part on the determination; and
communicate the first message using a set of parameters associated with the full-duplex operation based at least in part on the indication included in the downlink control information message.

19. The apparatus of claim 18, wherein the instructions are further executable by the processor to cause the apparatus to:
transmit, to the UE, a second downlink control information message scheduling the second message and comprising a second indication that the second message is scheduled for the full-duplex operation with the first message.

20. The apparatus of claim 19, wherein the instructions are further executable by the processor to cause the apparatus to:
communicate the second message based at least in part on the indication included in the second downlink control information message.

21. The apparatus of claim 20, wherein the instructions to communicate the first message and communicating the second message further are executable by the processor to cause the apparatus to:
receive, from the UE, the first message during a time interval based at least in part on the downlink control information message; and
transmit, to the UE, the second message during the time interval based at least in part on the second downlink control information message.

22. The apparatus of claim 18, wherein the indication comprises one bit of a field in the downlink control information message, the one bit indicating whether the first message scheduled by the downlink control information message is communicated using a full-duplexing mode or a half-duplexing mode.

23. The apparatus of claim 19, wherein the indication comprises a plurality of bits of a field of the downlink control information message, the plurality of bits indicating whether the first message scheduled by the downlink control information message is communicated using a full-duplexing mode or a half-duplexing mode, and information related to the full-duplexing mode or the half-duplexing mode.

24. The apparatus of claim 18, wherein the indication is included in a transmission configuration indicator state field of the downlink control information message or a modulation and coding scheme field of the downlink control information message.

25. The apparatus of claim 18, wherein the set of parameters comprise one or more of modulation and coding scheme tables, transmission configuration indicator states, control resource sets, power control parameters, self-interference measurements, cross-link interference measurements, puncturing parameters, rate matching parameters, uplink timing advance, a transmission power of an uplink signal, a second indication to modify the transmission power of the uplink signal, or a combination thereof.

26. The apparatus of claim 18, wherein:
the indication comprises a UE-specific indication; or
the downlink control information message comprises a UE-specific downlink control information message.

27. The apparatus of claim 18, wherein the instructions to transmit the downlink control information message further are executable by the processor to cause the apparatus to:
transmit the downlink control information message comprising the indication that the first message is scheduled to be communicated in a slot that is associated with full-duplexing.

28. The apparatus of claim 18, wherein the instructions are further executable by the processor to cause the apparatus to:
determine to include, in the indication, instructions for the UE to modify a transmission power used by the UE to transmit the first message.

29. A method for wireless communications at a user equipment (UE), comprising:
receiving, from a base station, a downlink control information message scheduling a first message and comprising an indication that the first message is scheduled for full-duplex operation;
identifying a set of parameters associated with the full-duplex operation of the first message based at least in part on receiving the downlink control information message that includes the indication; and
communicating the first message using the set of parameters associated with the full-duplex operation and based at least in part on the indication included in the downlink control information message.

30. A method for wireless communications at a base station, comprising:
determining to schedule a first message for full-duplex operation with a second message;
transmitting, to a user equipment (UE), a downlink control information message scheduling the first message and comprising an indication that the first message is scheduled for the full-duplex operation based at least in part on the determination; and
communicating the first message using a set of parameters associated with the full-duplex operation based at least in part on the indication included in the downlink control information message.
